(19) United States
(12) Patent Application Publication
(10) Pub. No.: US 2002/0116289 A1
(43) Pub. Date: Aug. 22, 2002

(54) Locker mobile pickup station

(76) Inventor: Ping Yang, Chino Hills, CA (US)

Correspondence Address: CHRISTIE, PARKER & HALE, LLP, P.O. BOX 7068, PASADENA, CA, 91109-7068, US

(21) Appl. No.: 10/055,144

(22) Filed: Jan. 22, 2002

Related U.S. Application Data
(63) Continuation-in-part of application No. 09/733,873, filed on Dec. 8, 2000.
(60) Provisional application No. 60/263,530, filed on Jan. 22, 2001.
(60) Provisional application No. 60/301,761, filed on Jun. 28, 2001.

(51) Int. Cl. G06F 17/60

(52) U.S. Cl. 705/26

(57) ABSTRACT

A method and system for scheduling delivery and delivery of products to buyers. A Mobile Pickup Station (MPS) server is placed within a computer network and receives product shipping instructions from buyers or third party sellers. The MPS server determines optimal pickup points using buyer commuting information and buyer delivery requests. A portable kiosk or locker station, enclosing buyers' purchases within individually lockable lockers, is placed at a pickup point chosen by the buyers. The buyers use access codes, such as a product ID and password, to unlock the lockers and receive their purchases.

### CROSS-REFERENCE TO RELATED APPLICATIONS

This application is a continuation-in-part of U.S. patent application Ser. No. 09/733,873 filed Dec. 8, 2000 and claims the benefit of U.S. Provisional Application No. 60/263,530 filed on Jan. 22, 2001 and U.S. Provisional Patent Application 60/301,761 filed Jun. 28, 2001 which are hereby incorporated by reference as if set forth in full herein.

### BACKGROUND OF THE INVENTION

This invention relates generally to the field of shipping and more specifically to the delivery of goods purchased from a distant location.

Conventionally, products that are ordered by consumers, whether are ordered on the Internet or by other means, are delivered primarily in two ways. In the first way, the buyer/consumer travels to the seller's store and picks up products ordered there. The second way, the seller ships the products to the buyer via common carriers and buyer receives products at the address designated. Both ways are inefficient. The first method costs the buyer the time and energy expended traveling to the seller's store to pickup products ordered. The second method on the other hand, costs the buyer shipping and handling charges and usually takes a considerable amount of delivery time for the products to be shipped.

The following patents generally indicate the level and depth of prior art shipping systems.

In U.S. Pat. No. 5,991,739, Cupps et al. disclose a system and method for providing an online ordering machine that manages the distribution of home delivered products over a distributed computer system. The patentee discloses that “The online ordering machine provides the customers with product information form various vendors whose delivery range is within the customer's location or with product information from vendors having a take out service within a specified range from the customer's location.”

In U.S. Pat. No. 6,026,375 Hall et al, disclose methods and systems for processing an order form a mobile customer and with the use of a method of global tracking a determination is made as to the completion of the order at a certain location at a certain time for the customer's arrival at that location.

Neither invention discloses a method and system that allows the seller to conveniently place a pickup station, which is mobile in nature and is easy to relocate, to a place close to the user's daily commute route and thereby provides maximum convenience for the buyer/user to pickup products ordered.

A conventional delivery system can be inefficient. Besides the problems conventional delivery system faced as previously discussed, the delivery of products to a buyer's address, normally made during daytime, can be troublesome. The buyer may not be present at the buyer's address to receive the products and the products may either be left unattended at the buyer's address or the buyer has to pick the products up later at a common carrier's office. Even when a delivery is made to an office location where presumably someone will be at the address to receive the products, problems may exist. This is because the common carrier comes and goes following its delivery route and those buyers at the end of the delivery route may waste a significant amount of time waiting for the products to arrive. This waste of time may be crucial and can't be remedied unless a buyer pays a higher price for a faster delivery.

As we move into the Internet era, more and more people shop on the Internet. But lots of people are turned away from Internet purchasing because the long delivery time and expensive delivery charges involved.

An improved delivery system providing a more efficient way of delivery is, therefore, needed. The present invention meets such need.

### SUMMARY OF THE INVENTION

In one aspect of the invention, a method is provided for scheduling and delivery of an ordered product to a buyer along the buyer's commuting route. The method includes receiving route information from a buyer such as a set of roads the buyer travels on the way to and from work. The route information is used to generate a route for which a pickup point is selected and dispatching a portable locker station enclosing the ordered product to the pickup point.

In another aspect of the invention, the route selection method includes selecting a set of landmarks along the buyer's commuting route. From the landmarks, a shortest distance route is generated for selection of the pickup point.

In another aspect of the invention, the route information supplied by the buyer includes at least two sub-routes. From the sub-routes, a complete route is generated by connecting the sub-routes with a set of shortest length routes.

In another aspect of the invention, the portable locker station includes a plurality of lockers for enclosing products, with each of the plurality of lockers having a unique access code. An access code is transmitted to the buyer for a locker enclosing the buyer's product which the buyer uses to unlock the locker and receive the purchases.

In another aspect of the invention, a data processing system is adapted to schedule and deliver an ordered product to a buyer along the buyer's commuting route. The data processing apparatus includes a processor operable coupled to a having stored program instructions. The program instructions are executable by the processor to receive route information from a buyer and generate a route from the route information. The process then uses the program instructions to select from a plurality of pickup points a pickup point based on the route and dispatch a portable locker station enclosing the ordered product to the pickup point.

In another aspect of the invention, a portable locker station includes a plurality of lockers, each of the plurality of lockers having an electronically actuated lock or bolt. A controller is electrically coupled to each of the electronically actuated locks and has means for storing a plurality of access codes associated with the lockers. A keypad, electrically coupled to the controller, is used by a buyer to enter an access code to unlock an associated locker.

In another aspect of the invention, the portable locker station further includes removable divides between adjoining lockers whereby a single locker is created from two or more lockers by removing the divider.

In another aspect of the invention, the portable locker stations further include a plurality of keypads with each keypad corresponding to a single locker from the plurality of lockers.

### BRIEF DESCRIPTION OF THE DRAWINGS

The features, aspects, and advantages of the present invention will become better understood with regard to the following detailed description, appended claims, and accompanying drawings where:

FIGS. 1, 2 are flowcharts showing the process from user's commuting route selection to user pickup at a mobile pickup station;

FIG. 3 is a flowchart showing an exemplary process to select available pickup points;

FIG. 4 is a flowchart showing third party buying coupling with a mobile pickup station delivery service;

FIG. 5 shows selection of mobile pickup point with two users;

FIG. 6 shows selection of mobile pickup point with new user joining in;

FIG. 7 shows the searching method by using user commuting route and user-selected channel;

FIG. 8 shows user's input of occurrence frequency;

FIG. 9 shows a mobile pickup station with panel in an up position.

FIG. 10 shows the overlapping of user channels and server's selection of available pickup points.

FIG. 11 shows a first model of the arrangement of shipping third party products to a mobile pickup station warehouse.

FIG. 12 shows a second model of the arrangement of shipping third party products to a mobile pickup station warehouse;

FIG. 13 shows a third model of the arrangement of shipping third party products to a mobile pickup station warehouse;

FIG. 14 shows a fourth model of the arrangement of shipping third party products to mobile pickup station warehouse;

FIG. 15 is a flowchart presentation of the searching method by using user-commuting route and user selected channel;

FIG. 16 is a network diagram depicting an embodiment of a MPS using the Internet as a communications medium; FIG. 17 is a diagram of a computer architecture of a general purpose computer capable of hosting a mobile pickup station server;

FIG. 18, 19, 20 are flowcharts of locker station operations in accordance with exemplary embodiments of the present invention;

FIG. 21a and FIG. 21b are an elevation and side view showing the construction of a locker station in accordance with an exemplary embodiment of the present invention;

FIG. 22 shows a MPS shipping sticker with order ID and bar code in accordance with an exemplary embodiment of the present invention;

FIG. 23 is a diagram presentation of multiple territories with covered routes in accordance with an exemplary embodiment of the present invention;

FIG. 24 shows a pair of lockers in a locker station in accordance with an exemplary embodiment of the present invention;

FIG. 25 shows the lockers in FIG. 24 with locker doors opened in accordance with an exemplary embodiment of the present invention;

FIG. 26 shows the lockers in FIG. 25 with divider in its up position in accordance with an exemplary embodiment of the present invention;

FIG. 27 shows the construction of divider and its relation to locker station wall in accordance with an exemplary embodiment of the present invention;

FIG. 28 shows two locker doors with the bolt at its down position in accordance with an exemplary embodiment of the present invention; and

FIG. 29 is a diagram presentation of a delivery system with subsidiary delivery personnel and transportation means in accordance with an exemplary embodiment of the present invention.

### DETAILED DESCRIPTION

The present invention is referred to herein a mobile pickup station (MPS) delivery system. A MPS delivery system uses pickup stations in the form of vehicles or movable kiosks used in conjunction with the Internet to provide maximum convenience for a buyer to pickup products. A mobile pickup station may be stationed along a buyer's frequent commuting route so that a buyer can conveniently pickup products at these stations when traveling via the buyer's usual commute route without spending extra time traveling to a seller's store to pickup products.

Most people commute to work via the same commuting route everyday. Others, while not working, go to the same place repeatedly. Even the time people start and end their commuting and the time spent on commuting are about the same day after day. The mobile pickup station system encompasses this highly routine human behavior by arranging to ship products a buyer ordered to a location that is close to the buyer's daily commuting route. Under such an arrangement, a buyer can pickup the products while conducting the buyer's daily commuting without spending extra time to travel to a seller's store for picking up and therefore making it convenient for the buyer to receive products. This pickup location will be referred to herein as the mobile pickup point.

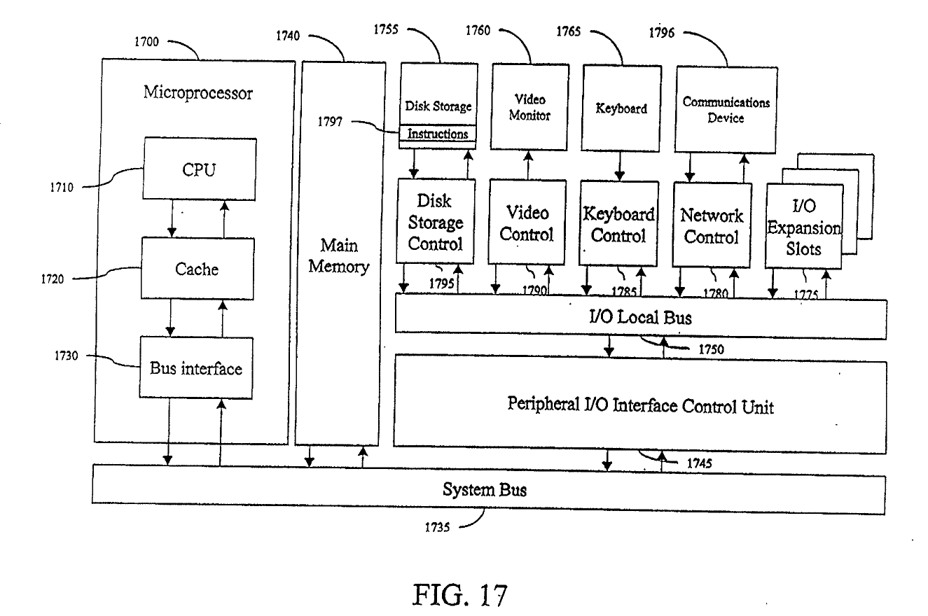

FIG. 16 is a network diagram showing an embodiment of an MPS server using the Internet. A MPS server 1660 is operatively coupled to the Internet 1604 via a communications link 1603 adapted for communications using the Transmission Control Protocol/Internet Protocol (TCP/IP) suite of networking protocols such as Hyper Text Transfer Protocol (HTTP) for hypertext document transfer and Simple Mail Transfer Protocol (SMTP) for the transfer of electronic (email) messages.

FIG. 17 is a hardware architecture diagram of a general purpose computer suitable for use as a MPS server host. Microprocessor 1700, comprised of a Central Processing Unit (CPU) 1710, memory cache 1720, and bus interface 1730, is operatively coupled via system bus 1735 to main memory 1740 and I/O control unit 1745. The I/O interface control unit is operatively coupled via I/O local bus 1750 to disk storage controller 1795, video controller 1790, keyboard controller 1785, and communications device 1780. The communications device is adapted to allow software objects hosted by the general purpose computer to communicate via a network with other software objects. The disk storage controller is operatively coupled to disk storage device 1725. The video controller is operatively coupled to video monitor 1760. The keyboard controller is operatively coupled to keyboard 1765. The network controller is operatively coupled to communications device 1796. The communications device provides a communications link adapted for communications over the Internet.

Computer program instructions 1797 implementing a MPS server are stored on the disk storage device until the microprocessor retrieves the computer program instructions and stores them in the main memory. The microprocessor then executes the computer program instructions stored in the main memory to implement a MPS server.

Referring again to FIG. 16, A buyer using a computer 1604 running an Internet browser to access the MPS server via the Internet. The buyer's computer is operatively coupled to the Internet via a communications link adapted for communications using TCP/IP based networking protocols such as HTTP for hypertext document transfer. The MPS server provides scheduling services for at least one regionally distributed MPS warehouse. Each MPS warehouse communicates with the MPS via the Internet using computers as exemplified by MPS warehouse computers 1606 and 1608. Each MPS warehouse computer is operatively coupled to the Internet via a communications link adapted for communications using TCP/IP based networking protocols such as HTTP for hypertext document transfer and SMTP for the transfer of email messages.

In operation, a buyer accesses the MPS server via the Internet and uses the delivery scheduling services of the MPS server to define a pickup point to be used by the buyer. The MPS server determines which MPS warehouse is to be used to dispatch a MPS to the defined pickup point with the buyer's products.

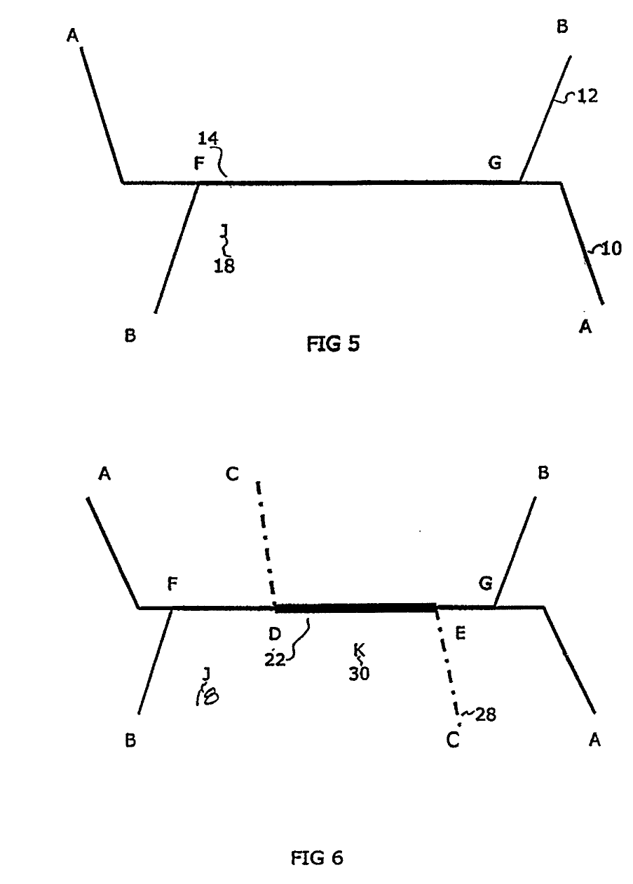

Referring to FIG. 5, user A and user B use the Internet for shopping and order products at the server's website. User A and user B identify their daily preferred commute route as route segment AA 10 and route segment BB 12 respectively. An MPS system stores this route segment information in its permanent memory. Route segment FG 14 is a route segment common to both route segment AA and route segment BB. A MPS system may achieve maximum convenience for both user A and user B by sending a MPS station which carries products ordered by user A and user B and stations at a place that is common to route segments AA and BB (e.g. point J 18) to wait for user A and user B to pickup their ordered products.

A MPS is a vehicle or a movable kiosk that has the capacity to carry products. For instance, in addition to the ability to carry general non-perishable products, an MPS may be equipped with an electricity generator that may power a refrigerator to carry food or floral products during summer, or a MPS may be equipped with a heating device to keep food products at an elevated temperature during winter . . . etc. In one MPS in accordance with an embodiment of the present invention, the MPS is connected to a power source, such as a solar power panel or a conventional electrical connection, to receive power to cool or heat products carries. In another MPS in accordance with an embodiment of the present invention, one or more operators or attendants stay with the MPS station to operate it, for example to give products to buyer when the buyer/user comes to the station to pick up product ordered or to receive products from the user when he come to the station to drop off products . . . etc. In another MPS in accordance with an embodiment of the present invention, _the movable kiosk has a plurality of lockers and the buyer or user is given an ID code and/or a password to open the locker to take the products he ordered. In this case, it would not be necessary to have an operator or attendant at the side of the kiosk to server the buyer/user. An exemplary MPS mobile pickup point (e.g. point J) is a place that is close to the overlapped user route (e.g. route segment FG), is easy to get access to from the user route and is convenient for the user to park or to walk to. It may be the parking lot of a shopping mall, a gas station or a wide street with capacity to park a MPS and user cars.

A mobile pickup point may also be a place where the MPS system can station a movable kiosk, such as subway station or at a street crossing etc. A MPS stays at the pickup point for a determined period of time waiting for users to pickup their orders. If the MPS station is a vehicle, an operator drives the station to the designated pickup point and stays there. If the MPS station is a movable kiosk, a truck may drop the kiosk at the designated pickup point and pick it up and return the MPS to a MPS warehouse when the station time is over for reloading.

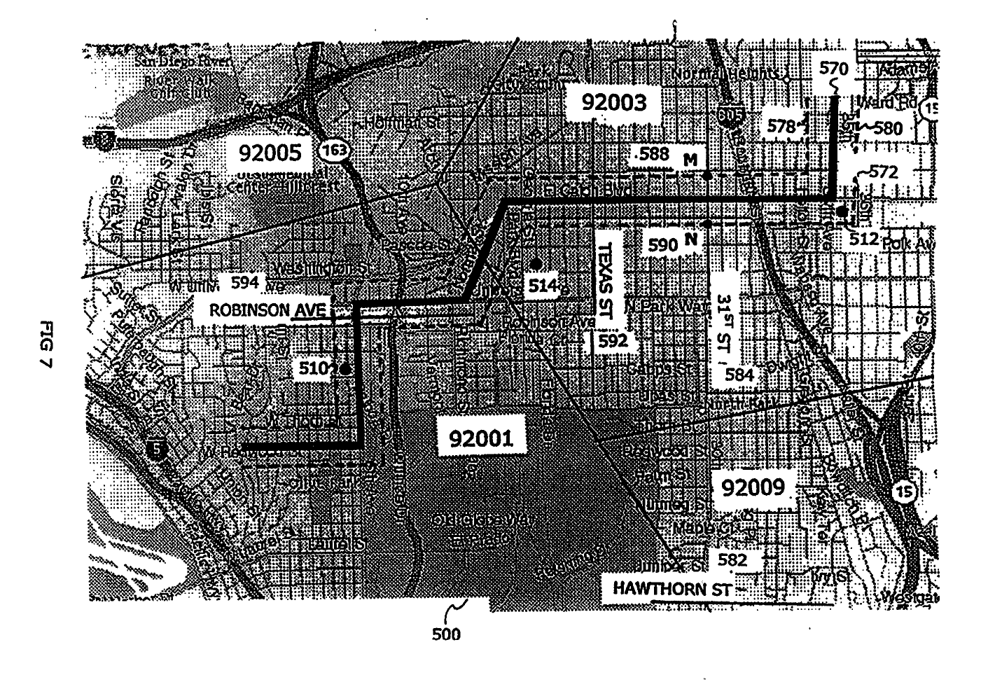

Referring to FIG. 6, assume user C joint a MPS system serving user A and user B. Further assume user C takes commuting route segment CC 28. Because pickup point J 18 is not within user C's commute route CC, the MPS system, in order to achieve maximum convenience to all users A, B, and C, must select a different pickup point to accommodate A, B, and C simultaneously. Point K 30, which is along route segment DE 22 and is common to all route segments AA, BB and CC, can thus be selected as a pickup point to serve users A, B, and C.

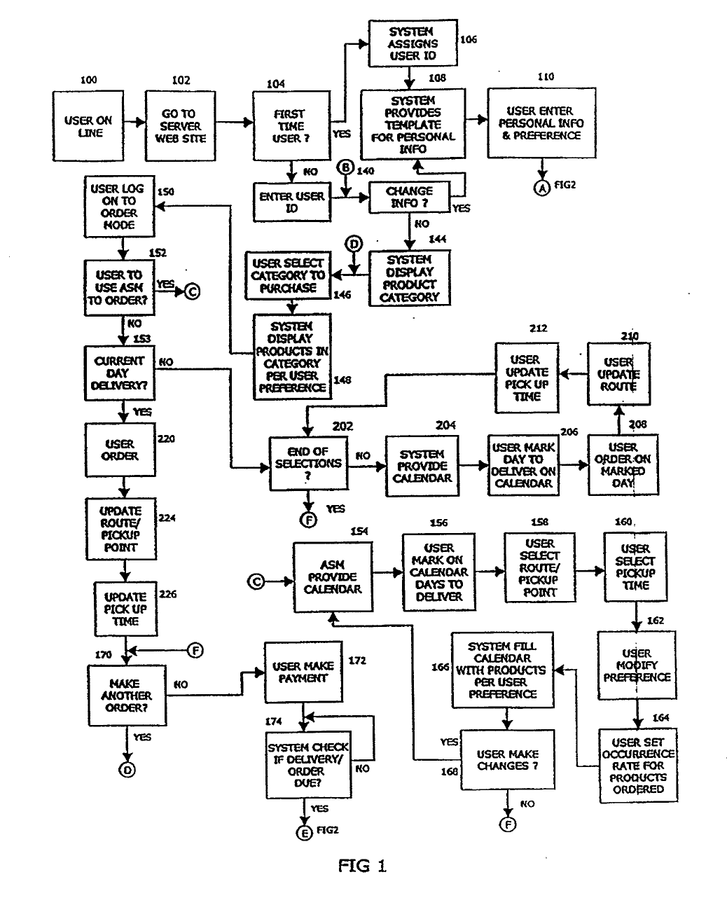

Referring to FIG. 1, a buyer uses at step 100 the Internet to access a Website using a personal computer (PC), a laptop, a palm pilot or any other means capable of accessing the Internet. The buyer is the person who purchases a product and/or MPS service from the Website. In the case where the Website is maintained by a transportation business entity providing MPS delivery services without selling any physical products, the buyer is the one who uses MPS services to have their products delivered.

The buyer goes to the Website hosted by a MPS server at step 102. An MPS server is a server maintained by a business entity that operates a MPS system. It may be a retail or wholesale business entity with a fleet of MPS stations. It may be a transportation business entity, which operates a fleet of MPSs and delivers products for its customers. Or it may be other kind of business entities, which operates a fleet of MPSs.

The server asks if the buyer is a first time buyer at step 104. If the buyer is a first time buyer, the system assigns the buyer an ID and a password for his use at step 106. The server provides a template for the buyer to enter his personal information at step 108.

The buyer may enter personal information such as name, address, phone number, age, credit card number, etc at step 110. At this stage, the server asks the buyer to enter preference of purchases. As herein used, purchases means purchases of products that include physical products and/or services. This preference is a tool the server uses later to screen products and display preferred products to the buyer. For example, if the server is maintained by a food manufacturing company, e.g. a food catering business, preference questions listed may be: does the buyer likes hot and spicy food? Should the food be slightly hot, medium hot, or very hot? If the buyer cares for red meat in the food? Maximum calorie count, fat count in the food, the buyer likes Italian food, Japanese food or others etc. Also the preference questions may contain dollar limitations the buyer wants to spend on meals.

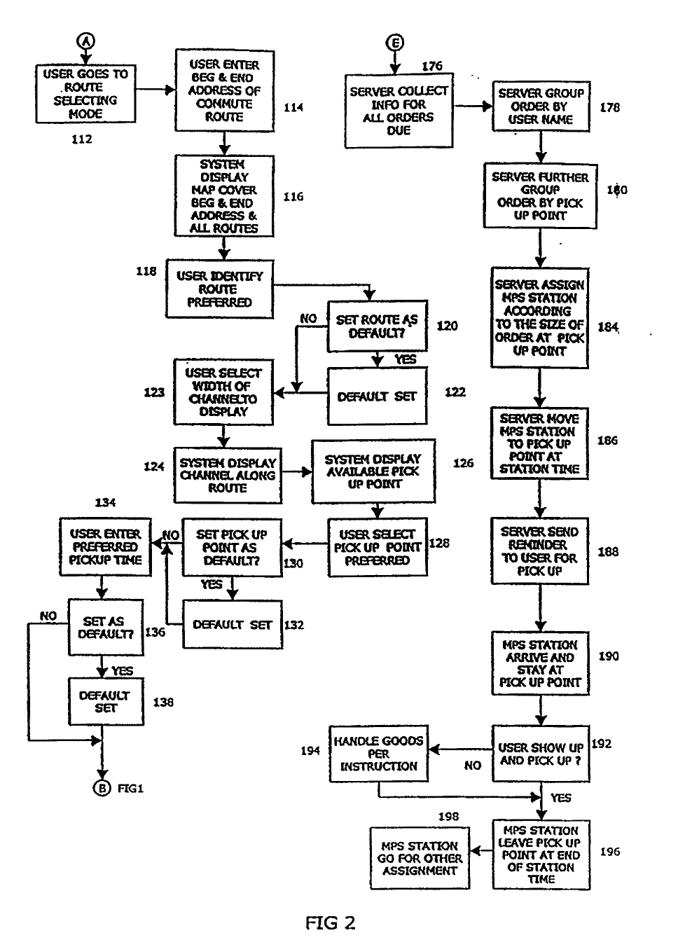

Referring to FIG. 2, the buyer then goes to a route-selecting mode at step 112 to choose a commuting route. In this mode, a template is presented to the buyer to enter the beginning and the end addresses of the buyer's commuting route at step 114. Once the beginning and the end address of route are defined, the MPS server displays a map with all the possible routes involved at step 116. In another embodiment if a MPS in accordance with the present invention, in defining beginning and end route information, the buyer/user is allowed to enter the zip codes or the telephone numbers of the beginning and end of the route. The system can then identify the general area of the beginning and end of the route and display a map that covers the general area of the beginning and end of the route with all possible routes available to the user. Well-known landmarks, city names or the cross streets with city information at each end of the user route can be used to identify the general area of the route in a similar fashion. When the system allows the user to enter the telephone number at each end of user route, the system uses the area codes and the prefixes of the telephones numbers to identify the general area of the beginning and end of buyer/user's commute route and displays the map.

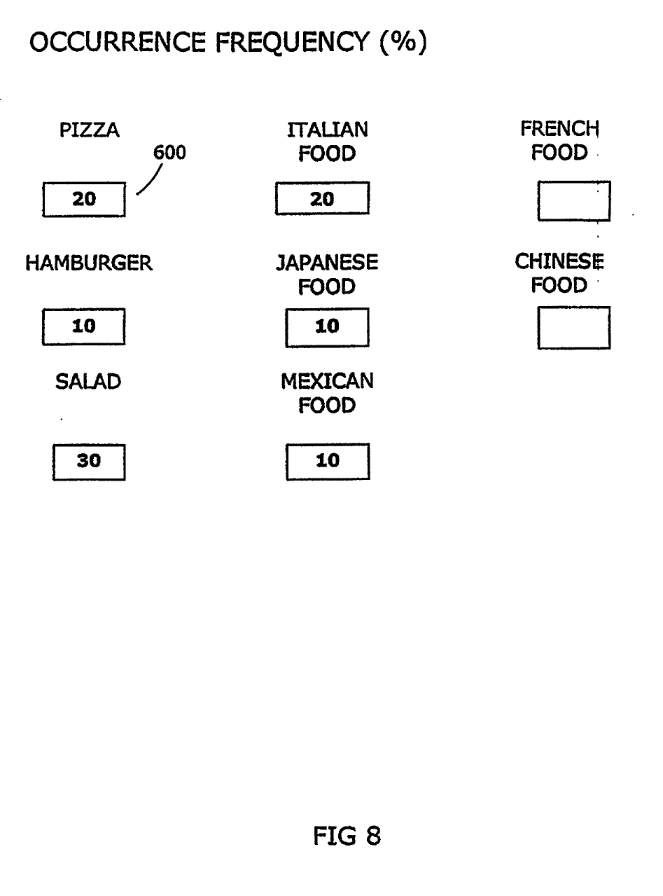

Referring to FIG. 7, in one embodiment of a MPS server, a MPS server displays a map 500 that covers the beginning and end address of the buyer's commute route. The map may display all streets and freeways between those two ends. The buyer clicks or depress-and-drags the mouse across the map to define a chosen route 570. In another embodiment of the present invention, a buyer is prompted to enter a distance from the buyer's chosen route that the buyer is willing to travel to pickup a product. The distance a from the buyer's chosen route that the buyer is willing to travel is herein termed a channel width. The channel width is used by the MPS server to define channel boundaries 578 and 580 around the chosen route. This channel width combined with the buyer's chosen route creates a channel 572. The buyer may use this channel as a distance reference. Or the buver may indicate to a MPS server that this channel width is the distance the buyer is willing to travel away from the buyer's commute route.

In another embodiment to define a route, the server may allow the buyer to enter the names of some or all the streets or highways the buyer prefers to travel, the MPS server will connect those streets or highways together with the shortest distance and further connect the buyer's beginning and end addresses to build a chosen route.

The buyer may use the following procedures to click and build his chosen route on a map 500. The buyer starts with his beginning address, e.g. his home address, at this time the MPS server registers a reference point, which is the buyer's home address on the buyer's home street. The buyer then clicks on the map a second street the buyer will travel. The intersection of the second street and the buyer's home street become a second reference point.

The system registers the route between the first and the second reference points as a portion of buyer's chosen route. The buyer then clicks a third street the buyer will travel. The intersection of the second and the third street becomes a third reference point. The MPS server then registers the route between the second and the third reference points as a portion of the buyer's chosen route. The buyer keeps going on with the process until the buyer reaches the buyer's end address, which would be the buyer's final reference point. The MPS server registers a final route portion and the whole route may thus be identified as the buyer's chosen route.

Alternatively, the buyer starts a route selecting process by clicking on the map one of the streets within the buyer's commuting route, the buyer then clicks on the map the streets the buyer travels before and after that street. The system then use the intersections of these streets to establish reference points for the MPS server to construct the buyer's route. In the case where the buyer forgets or neglects to click to identify any of the traveled street(s) within his route, the system searches street(s) that represents the shortest traveling distance between the clicked streets and connects those clicked streets. The same method can be used to connect the clicked streets to the buyer's beginning and/or end points of route. For example, if the buyer clicks the second and the fourth traveling streets, thus creating a set of sub-routes, and forgets to click the third traveling street in the route, the system then generates a route by connecting the second and the fourth street with street(s) with a sub-route that represents the shortest distance between the two sub-routes to complete a whole route.

In another embodiment of a route selection system in accordance with the present invention, after the user enters telephone numbers, zip codes, city names or landmarks to identify the beginning and end of a route, the system displays a map that covers the general area of the route as previously described, the user can then use his mouse to point the cursor at the places he wishes to travel, and click on them. The system will then register those clicked points as reference points to establish the route. This method can be used to establish the beginning and end of a user route.

In another embodiment of a route selection system in accordance with the present invention, the system may present to the buyer a default route with the shortest travel distance when the beginning and the end of the route are determined. Major highways and/or major streets may be incorporated into the default route. The buyer is allowed to change any portion of the default route as he wishes. A template may be provided to the buyer to enter via keyboard the highways or streets buyer wants to travel. A drop down menu that contains defaulted streets and/or highways may be used to allow the buyer to click on and select his desired traveling route.

The buyer chooses a channel width, e.g. ¼ mile. The MPS server displays two channel boundaries 578 and 580 that wrap around and extend along the chosen route 570 with the distance from a boundary to the chosen route equal to ¼ mile. The area between the channel boundaries defines a channel around the chosen route. The MPS server displays all available pickup points 510 and 512 covered by the channel.

If there are no pickup points within the channel, the MPS server then displays those pickup points around the channel such as point 514. The MPS server at this time may decide if the MPS server wants to relocate a pickup point to a place within the channel or the MPS server will wait till condition permits, e.g. more buyers use the same route, to establish an extra pickup point to serve the buyer. If the MPS server determines that no new pickup point should be established, the buyer selects a pickup point (e.g. 514) outside of the buyer's channel.

Referring again to the process flow diagram of FIG. 2, the buyer selects a width for the MPS server to develop a channel around a chosen route at step 123. The MPS server then displays a channel that wraps around and extends along the route at step 124 with the defined width. The buyer then clicks or depresses and drags the mouse key on the map described in FIG. 7 to define the buyer's chosen route at step 118.

The buyer can choose to set the chosen route as a default route at steps at step 120 and at step 122. If the chosen route is a temporary route because the buyer is temporarily traveling along a new commute route, the buyer may not want to set the chosen route as a default route.

The MPS server displays the channel as previously described in FIG. 7. The buyer uses the buyer's mouse to click a pickup point at step 128. The buyer can set the pickup point to be the buyer's default pickup point if the buyer desires, see steps 130 and 132. The buyer also may enter the buyer's preferred pickup time at step 134. He may also set this pickup time as a default at steps 136 and 138. The server may set a station time as the time a MPS stays at the pickup point. For example, the MPS server may set station time between 4 p.m. to 7 p.m. or 6 a.m. to 9 a.m and the buyer comes between those times to pickup the buyer's products. If no station time is set, a MPS may stay at the pickup point until all buyers pickup their products.

The pickup time entry, in the case of no station time being set, gives the MPS server a planning tool as how long a MPS w2ill stay at a pickup point before the MPS is sent to a next assignment.

In one embodiment of a MPS server, the pickup time entry may be also used as a guide to send a reminder to the buyer for pickups. For example, if a buyer enters 7:30 a.m. as the buyer's pickup time, the MPS server may send a reminder at 7:00 a.m. to the buyer to remind the buyer that he has an order to pickup. The reminder may be very important if the order is to be picked up early in the morning. The reminder may be in the form of telephone calls to the buyer's office, home, or cellular phone. It may also be in the form of e-mails or messages sent to a buyer's palm pilot or it may be by other means permitted by technology.

Referring again to FIG. 1, after finishing input of all setup information, a buyer proceeds to step 140. The MPS server displays product categories for the buyer to choose if the buyer does not want to change any information at step 144. Product categories are different groups of products sold by a seller. For a food producing company (e.g. a food catering business or a lunch/dinner delivery business) the categories may be: drinks, wine, Italian food, French food, Japanese food, deserts, pizza or other products the server is selling. The MPS server may display only those categories that match the buyer's preference and disregard those that the buyer is not interested in purchasing. The buyer clicks on the category the buyer wants to purchase at step 146. The MPS server brings up all products under category buyer selected at step 148. The products displayed may be subject to the same screening process as previously described, which is, only products that match the buyer's preference are displayed and any other products are disregarded. The MPS server displays product features along with products. Those features displayed may be: ingredients, calorie counts, fat count, and price etc. The MPS server may also employ newly developed technology that gives out the scent of the food when buyer reviews its product information to stimulate purchases. The buyer, after reviewing product items, decides to order and goes to order mode at step 150.

In one embodiment, a MPS server provides an Automatic Selection Method (ASM) service. This is a MPS server service designed for a buyer, who does not want to go through the trouble of ordering repeatedly and, after establish the buyer's preferences with the MPS server, want the MPS server to fill orders for the buyer according to the buyer's preferences. As an example, a buyer, who has set up a buyer's preference as follows: calorie under 600, fat under 30 grams, no red meat, no onion etc, wants to use the MPS server to order food at step 152.

The MPS server follows the following steps to fill orders for him: The MPS server displays a calendar at step 154. The buyer marks on the calendar to indicate the days on the calendar the buyer wants to order products to be delivered at step 156. The buyer can choose to set different routes, pickup points and pickup time for each day on the calendar as described in steps 112-138 (FIG. 2). The buyer may use a default route; pickup point or pickup time information as previously entered in steps 158 and 160. The buyer can modify the buyer's preference if the buyer desires at step 162. The buyer may set up the “occurrence rate” for each product to appear on the buyer's menu at step 164. Occurrence rate is the percentage of times an item appears on the buyer's total orders.

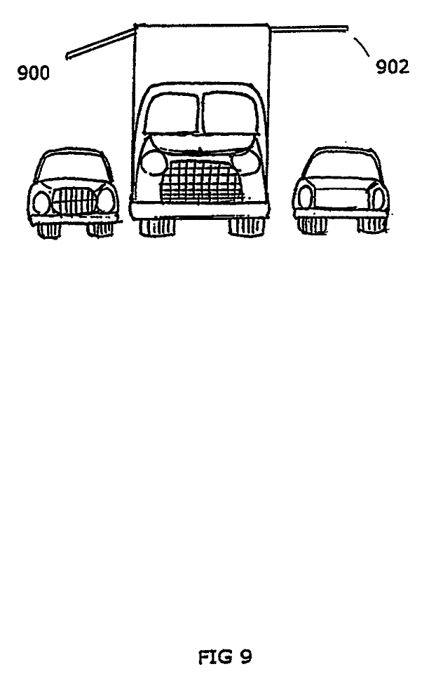

FIG. 8 is a sample template for a buyer to enter occurrence rates. An entry of a 20% occurrence rate for pizza 600 means the buyer wants 20% of the buyer's total orders to be pizza when the MPS server fills orders for him using ASM service. The MPS server can also be set up so that the same item will not appear twice consecutively.

Referring again to FIG. 1, the MPS server randomly fills orders for the buyer according to the buyer's preference and occurrence rate entered at step 166. If no change is to be made about the orders, the buyer then decides if the buyer wants to place orders in other categories at steps 168 and 170. If the buyer wants to place an order in another category, the buyer goes to category selection at step 146 and follows the same procedure as described before. If buyer does not want to shop for any other categories, the buyer makes payments at step 172.

The MPS server regularly checks buyer orders to see if there is any order or delivery that is due at step 174. If an order is due the MPS server prepares for production or makes inventory requisitions.

Referring again to FIG. 2, the MPS server collects buyer's names, pickup points, pickup times and other related information for due orders at step 176. The server first groups orders by buyer name at step 178. The MPS server may keep a total of all orders that have identical or nearby delivery addresses. The MPS server decides how physically close those addresses are to be qualified as “nearby”. A delivery address is part of the information a buyer inputs when a buyer enters their preferences. Delivery addresses are the addresses an MPS server will deliver products to, when the following circumstances occurs. The MPS server may decide that it is feasible for the MPS server to deliver products to a buyer at the buyer's physical address, (not deliver to a MPS pickup point for buyer to pickup, but deliver to the buyer's physical delivery address), if orders with the same or nearby delivery address are over a predetermined amount. Once the MPS server decides it is feasible to deliver, the MPS server sends a message to those related buyers notifying them that the products they ordered will be delivered to their delivery addresses. For buyers that agree to the delivery, the MPS server arranges the products to be delivered to them at their delivery addresses.

For those orders the MPS server does not deliver to a buyer's delivery address, the MPS server further groups those orders by pickup points at step 180. At this time, all orders are grouped by buyer name and by pickup point and are waiting to be shipped by MPS to MPS pickup points. The MPS server calculates the size of the load (orders) that needs to be shipped to the MPS pickup point and assigns a MPS with enough capacity to execute the shipment at step 184. The MPS, after being loaded with orders, is dispatched to an assigned pickup point at step 186. The MPS server can determine the timing of dispatching MPSs to pickup points. For example, if a MPS is needed at a pickup point at 4:00 PM and MPS server also determines that the time spent on travel from the MPS server's warehouse to a MPS pickup point is about 1 hour, the MPS server determines that the MPS should leave the MPS warehouse at about 3 PM.

A MPS server may send out a reminder to a buyer to remind the buyer to pick up the buyer's products at step 188. The reminder may be sent by e-mail, a telephone call to a buyer's cellular phone or office, or by sending a message to the buyer's palm pilot. With a buyer who equipped with Mobile Location Determination System (MLDS), Global Positioning System (GPS) or car navigation system, the MPS server may, upon detecting that the buyer is near the buyer's pickup point, send a message to the buyer to remind the buyer to pick up products ordered and give the buyer the directions to the pickup point.

When a MPS arrives at a pickup point, the MPS stays there for the station time at step 190 and waits for buyers to pickup products at step 192. In the case where the MPS is a locker kiosk without an operator or attendant, the station time may be longer then those stations with operators or attendants. The MPS may install a sign, fly a balloon, or turn on a search light for buyer's easy identification. Also, a MPS may have microwave ovens for the buyer's convenience in heating up food the buyer picked up.

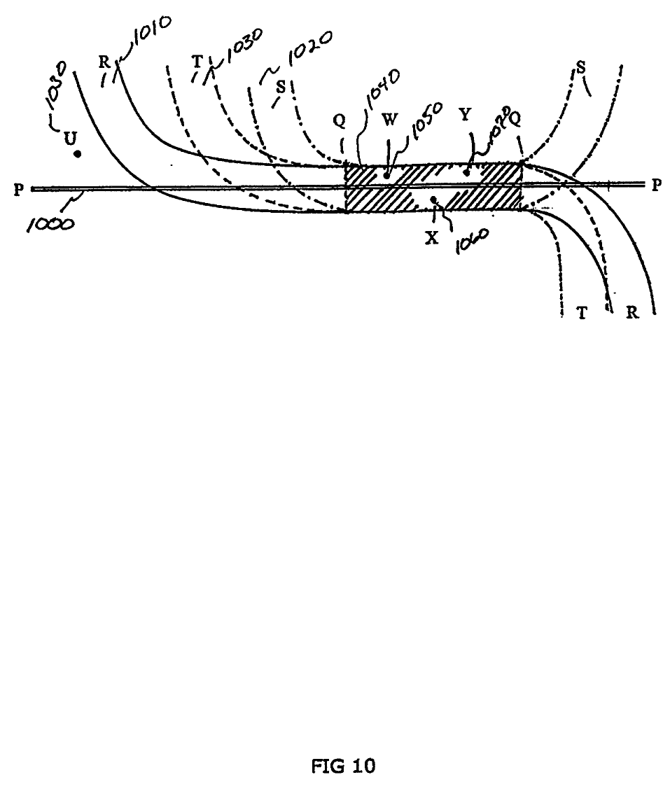

Referring to FIG. 9, a MPS may also install a panel 900. When the panel is pulled up to the panel's up position 902, the panel will shelter a buyer from the rain, snow or sunlight. When in the case the MPS is a truck, the panel provides the buyer a “drive-thru” lane. A buyer can thus pickup products ordered without leaving the buyer's car.

Referring again to FIG. 2, when a buyer picks up a product at step 192, the operator of a MPS, if assigned, may want the buyer to sign a receipt as evidence of receiving products. If buyer fails to pickup orders at step 194, the MPS operator may follow the buyer's instructions as how to handle those non-picked up products. A MPS server may give instructions such as: return those non-pickup products to a MPS warehouse for re-delivery or sell the non-picked up products for whatever the operator can sell and credit the buyer for the amount sold etc. When the station time is up, the MPS leaves the MPS pickup point (or being picked up by MPS server) at step 196. For the maximum use of an MPS, it may be moved to another location to carry out other assignments at step 198.

If the buyer wants to order manually instead of using an ASM service to order at step 152, also if the delivery is not for the current day at step 153 and the selection of order is not complete at step 202, the MPS server provides a calendar at step 204 for the buyer to select the days of order/delivery desired. The buyer manually marks on calendar the days the buyer wants to order a product and have it delivered at step 206, and the buyer fills those days with an order at step 208. The buyer may specify a different route at step 210 and pickup time at step 212 for each day by using the same procedure as described before.

If the manual selection of orders is complete at step 202, the buyer makes decision as to whether the buyer wants to make other orders at step 170. If the buyer does want to make other orders, the buyer selects a category at step 146, if not, the buyer makes payments on the existing orders at step 172. If the buyer wants to order manually instead of using an ASM service at step 152, and if the order/delivery is for the current day at step 153, the buyer goes into the order mode and places an order at step 220. The buyer may change route, pickup point at step 224 and pickup time at step 226 as previously described.

As previously described, after a buyer establishes the buyer's chosen route and defines a channel width, a MPS server presents available pickup points within or around the buyer's channel for buyer's selection. Several different methods may be used by a MPS server to determine available pickup points for the buyer's selection.

An approximate method may be used when the MPS server does not have enough information about buyers' chosen commuting routes to establish a buyer route distribution within a region. The MPS server may then use traffic volume on a route (i.e. a highway or a street) as a guide to approximate buyer route concentrations and place available pickup points along the route for buyer selection. A highly traveled highway may be assumed to have a high route concentration. The same assumption may be made for a busy major street. The MPS server may thus present pickup points along those routes. Other criteria in determining available pickup points may be considered and will be disclosed later.

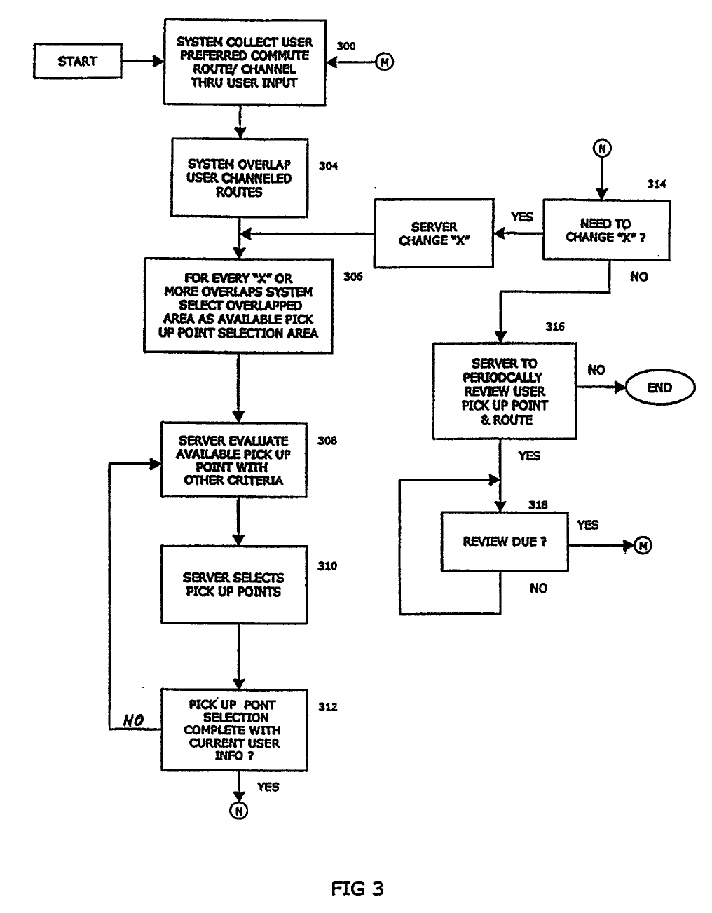

FIG. 3 is a process flow diagram of a method used by a MPS server for selecting a route using an overlap route method. In this method, the MPS server collects buyer chosen commute routes and channels from buyer input at step 300. The MPS server then overlaps all channeled chosen routes defined by all buyers at step 304. The MPS server may for every overlapped area select the overlapped area as an area for available pickup points at step 306. In addition to overlapping, the MPS server may consider other criteria at step 308. Other criteria the MPS server might consider are: is rent involved for using a pickup point? How much is the rent? Is the pickup point far away from the buyer's route? Is the pickup point convenient to get access to from a buyer's route? Is parking sufficient? Is the pickup point easy to identify etc. The MPS server makes a decision and selects available pickup points at step 310.

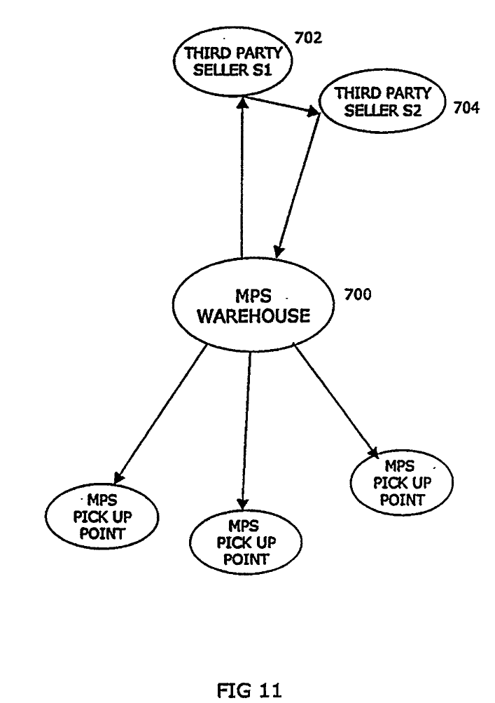

A buyer chooses a buyer's chosen pickup point and/or default pickup point among those available pickup points provided by the MPS server. If the MPS server needs to provide more pickup points to the buyer, the MPS server goes to step 308 for more selections. The MPS server may change parameters to expand or contract the area of available pickup points at step 314. From time to time, the MPS server may periodically review buyers' chosen commuting routes at step 316 to see if buyer route distributions have changed. If buyer route distributions have changed, the MPS server can correspondingly reposition its pickup points to better serve buyers. If the time for route reviewing is due at step 318, the MPS server starts the whole process all over to update the MPS pickup point positioning at step 300. FIG. 10 is a graphical representation of a MPS pickup point area assessment. Assume that PP 1000 is a route, e.g. a highway or a major street with heavy traffic. Buyers R, S, and T each have a buyer's chosen route. Buyer R has chosen route RR 1010, buyer S has chosen route SS 1020, and buyer T has chosen route TT 1030. Also assume that in the beginning, a MPS server does not have any route information pertaining to buyers R, S, an T. the MPS server can only use an approximate method to choose a pickup point, for example, point U 1080. Under this method, buyers R, S, and T have to travel out of their chosen channels to get access to point U.

Now assuming the buyer routes are available to the MPS server. The MPS server overlaps all chosen channels from for all of the buyers to form an overlapped area QQ 1040. Area QQ will be qualified as a pickup point selection area, because QQ is the area overlapped by multiple chosen routes, namely, RR, SS and TT. The MPS server may propose pickup points within this available pickup point selection area QQ to a buyer wishing to pickup a product.

Now assume that points W 1050, X 1060, and Y 1070 are locations inside area QQ that the MPS server considers as possible pickup points. Also assume that point W is a parking lot in a major super market, W is also close to route PP and easily accessed from route PP. The MPS server selects W to be a pickup point after the MPS server considers all criteria. Point W is then presented to buyers R, S and T and W can be chosen as a pickup point. A buyer may then abandon their original pickup point U and position the new pickup point at W. The MPS server may propose more than one available pickup point in an available pickup point selection area depending upon buyer route concentration, e.g. X or Y may be selected as available pickup points also if the MPS server desires.

In another embodiment of the present invention, a MPS server acts as a third party delivery MPS server. A third party is a business entity other than the entity providing the MPS server itself that has an agreement with a MPS server to use a MPS server services to serve the third party's customer. For example, a local flower shop may receive orders on line from a buyer. The flower shop allows the buyer to access a MPS server operated by an entity other than the flower shop so that the buyer can use the MPS server to position a pickup point and pickup flowers ordered there. This flower shop is a third party seller.

Sometimes a third party seller's customer may already have a preferred MPS pickup point established with a MPS server because of previous orders with other companies. In this case, the third party seller only needs to confirm that the buyer wants to use the MPS service to pickup flowers ordered, the flower shop then makes arrangements with the MPS server so that the flower ordered may reach the pickup point for the buyer to pickup. The arrangements between the third party seller and a MPS server with regards to the shipment of products from the third party seller to a MPS warehouse may take many forms and will be discussed in more detail later.

Upon receipt of the third party's products, a MPS server searches to see if the buyer has other orders that can also use MPS service. If the buyer does have other orders, the MPS service groups all orders pertaining to the same buyer and uses a single MPS to deliver those products to a MPS pickup point for pickup by the buyer.

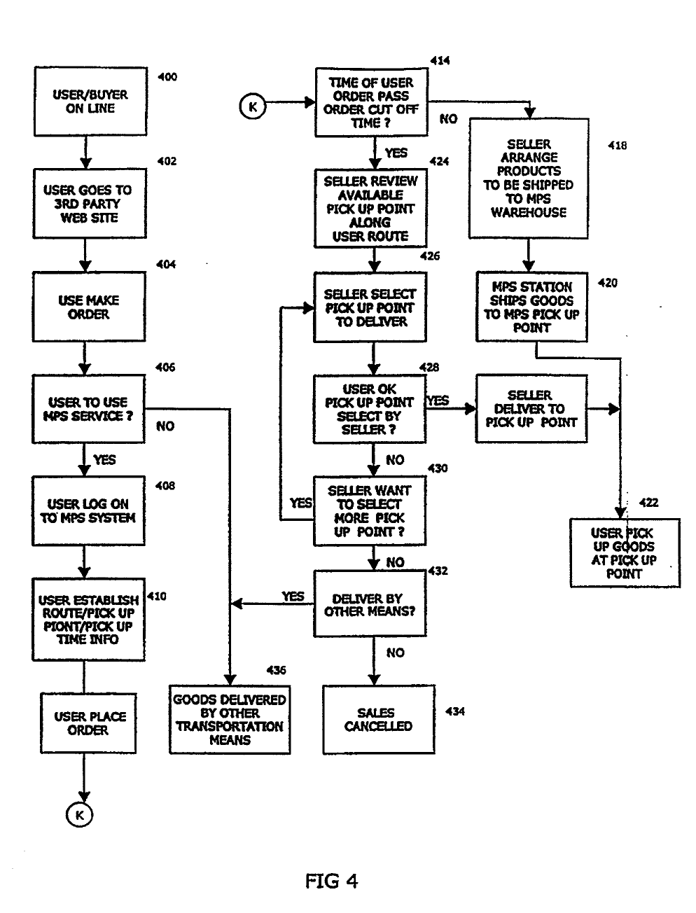

FIG. 4 is a process flow diagram of a third party seller ordering process. A buyer goes on to the Internet at step 400, and goes to a third party's Web site at step 402. The buyer makes orders at step 404, the buyer then makes decision as to what delivery options the buyer will use at step 406. The buyer decides if the buyer wants to use conventional delivery methods to ship the buyer's order, which usually involves shipment by common carriers (e.g. by UPS or US Post Office), or uses MPS pickup MPS server so that the buyer can pickup the buyer's order at a pickup point. Assuming the buyer wants to use a MPS service, the buyer goes to a MPS server Web site at step 408.

At the MPS server Web site, the buyer either sets up to establish a pickup route and pickup point with the MPS server or updates route and pickup point information already established with the MPS server from previous purchase with the MPS server at step 410. The third party seller keeps a record of the buyer's order together with all related shipping information.

The third party seller may establish an order cut off time, which is the latest time for order receiving. An effective cut off time allows the seller enough time to pack and arrange ordered products to be shipped to a MPS warehouse before a MPS server dispatches to MPSs to pickup points. For example, assume a MPS leaves a MPS warehouse the heading for a MPS pickup point at 3:30 PM. Also assume that it takes 30 minutes for the seller to process and pack orders and it takes another 30 minutes for the products to be shipped to the MPS warehouse, the order cut off time will be set at 2:30 PM. If a buyer orders before cut off time at step 414, the third party seller then arranges the ordered products to be shipped to the MPS warehouse at 418.

There are various ways products can be shipped to a MPS warehouse, which will be disclosed later. Once ordered products are shipped to a MPS warehouse, the products are loaded on to a MPS and then the MPS moves to a MPS pickup point at step 420 and waits for buyers to pickup up products at step 422.

In the case where a buyer orders after the cut off time of 2:30 PM, as set in the above example, the third party seller may impose an extra delivery fee to deliver the order to a preferred pickup point and the buyer can pickup the buyer's order at that pickup point. In this case, the third party seller logs on to a MPS server. The MPS server displays a map that covers the third party seller's location and the buyer's route at step 424. The MPS server also displays the buyer's default pickup point and other available pickup points near the route. The seller selects a pickup point for delivery at step 426 and quotes the buyer the price of delivery to that pickup point. If buyer agrees with the quotation and other terms at step 428, the products are delivered to that specified pickup point for buyer to pickup at step 422. If no pickup point is satisfactory to the buyer, other arrangements have to be made at step 436 or the sale is cancelled at step 434.

As previously discussed when discussing step 418 of FIG. 4, various arrangements for the shipment of products from a third party seller's store to a MPS warehouse may be made. These arrangements may take many forms.

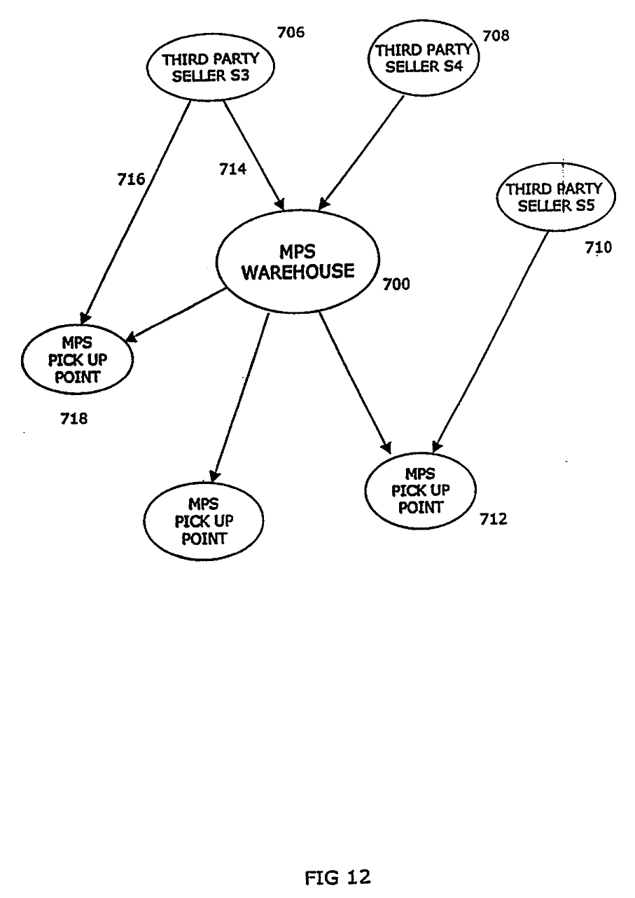

In one embodiment of a MPS server, as illustrated in FIG. 11, a MPS warehouse 700 sends out transportation equipment, e.g. MPSs, to the warehouses of a third party seller S1 702 and a third party seller S2 704 to pick up products ordered by buyers. The MPSs then go back to the MPS warehouse for packing and distribution or goes directly back to the assigned pickup points for user to pick up goods users ordered.

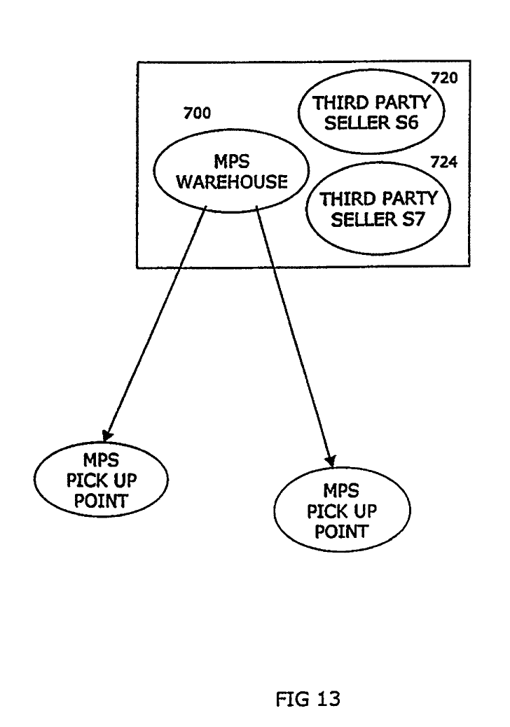

In an alternative embodiment of a MPS server, as illustrated in FIG. 12, a third party seller S3 706 and a third party seller S4 708 ship buyer ordered products to a MPS warehouse 700 by their own transportation means or by common carriers. S5 710, another third party seller, which is local to one of the pickup points 712, may choose to ship buyer ordered products directly to the pickup point 712. A MPS that stays at pickup point 712 receives the products and waits for a buyer to pickup the products. Third party seller S3 may use route 716 to deliver a portion of orders directly to a pickup station 718 and at the same time deliver another portion of orders to the MPS warehouse 700.

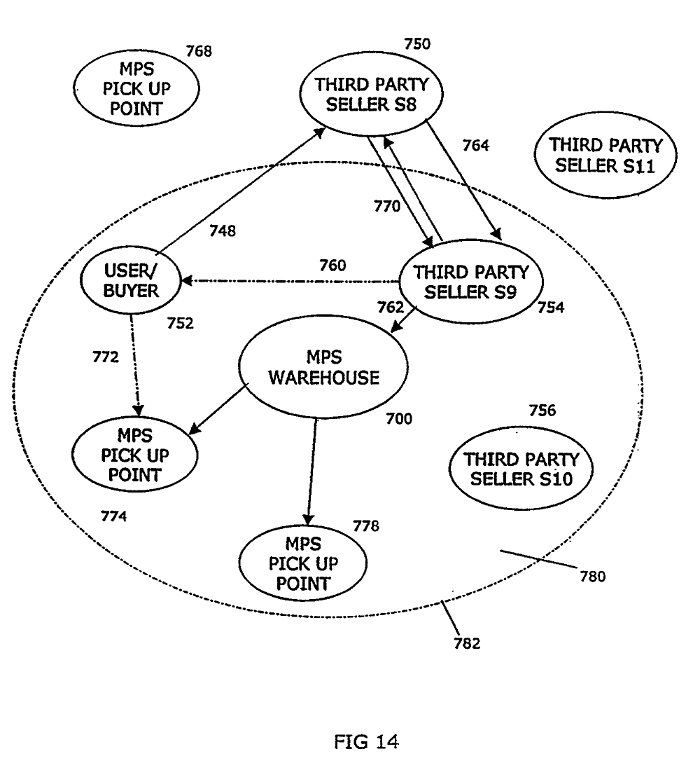

In another alternative embodiment of a MPS server, as illustrated in FIG. 13, third party seller S6 720 and third party seller S7 724 can be at the same location with a MPS warehouse 700. The third party sellers may be different entities that share the same warehouse or they may be different divisions that belong to the same entity. In this model, because the third party sellers are so closely located to each other, the order cut off time can be close to the time MPSs are dispatched to pickup points.

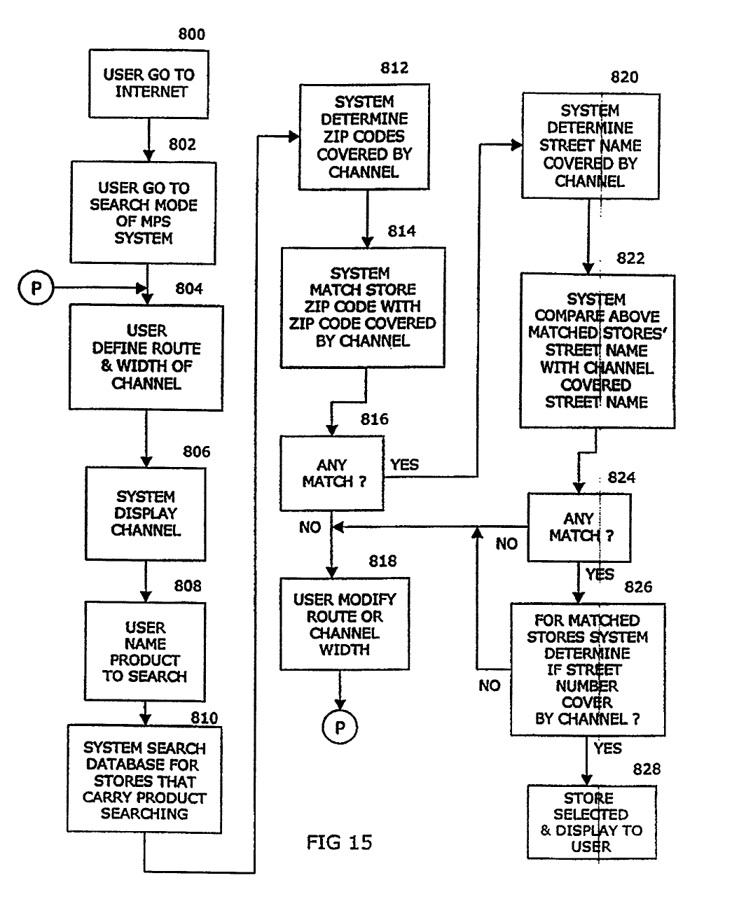

In another alternative embodiment of a MPS server, as illustrated in FIG. 14, third party sellers loan each other products to ease short term deficiencies in product supplies at a buyer's location. Assume that a third party seller S8 750 is a distant third party seller away from a MPS warehouse 700. A distant seller is a seller that is located far away from a MPS warehouse that serves a buyer. A seller S8 750 receives an order from a buyer 752 via the Internet or by other means 748. Assuming a third party seller S9 754 and a third party seller S10 756 are affiliates to S8 and each has an inventory loan agreement with S8. Third party sellers S9 and S10 may be related or unrelated business entities, or strategic partners to third party seller S8. Or third party sellers S9 and S10 may simply be warehouses owned by and apart from S8. For the purpose of this case, third party sellers S9 and S10 may be any kind of entities as long as third party sellers S9 and S10 have inventory loan agreements with third party sellerS8.

In this case, third party seller S8 receives an order from a buyer and contacts third party sellers S9 and S10 to see if third party sellers S9 and S10 carry the same products as the products the buyer ordered. Third party seller S8 finds third party sellers S9 and S10 by using a search method called “Territory Search Method” to be described. Third party seller S8 then checks to see if third party sellers S9 or S10 can loan the item to third partv seller S8 by shipping to the buyer the identical products the buyer orders. If both third party sellers S9 and S10 carry the ordered products, third party seller S8 proceeds with the loan transaction arrangement with the third party seller who would charge third party seller S8 the least. For example, if third party seller S9 is willing to proceed with a loaner transaction with third party seller S8, third party seller S9 ships a product the buyer ordered to the buyer's previously described delivery address or to the buyer's previously described preferred MPS pickup point based on the shipment method the buyer prefers. At this point third party seller S8 owes an identical product to third party seller S9. To perfect and secure the transaction to be an inventory loan transaction between third party sellers S8 and S9, agreements 770 between third party sellers S8 and S9 should be maintained. Such agreements may include provisions such as: third party seller S9 will be paid back by receiving the identical products from third party seller S8 only; third party seller S9 is paid a processing fee for the loan arrangement; third party seller S9 will not be paid for the products loaned by money; third party seller S9 does not receive any exchange for other products from third party seller S8; third party seller S9 will ship products to the buyer only after third party seller S9 receives a confirmation from third party seller S8 stating that identical products have been shipped to third party seller S9; and third party seller S8 is the party solely responsible for the quality of products shipped and any related customer-seller dispute will be resolved between third party seller S8 and the buyer. In a product loan transaction, third party seller S9 never sells any products and keeps the same amount of inventory on the buyer's book. In reality, the buyer may not even realize that third party seller S9 exists. Any legal arrangements that may deal with title, risk, responsibility, insurance or others, as long as it will make this transaction a sale between the buyer and third party seller S8 and not a sale between the buyer and third party seller S9 will be instituted.

After third party seller S8 750 receives an order 748 from the buyer 752, and after the third party seller S8 and the third party seller S9 754 have secured an inventory loan agreement 770, third party seller S9 ships the products ordered to the buyer. Third party seller S9 may ship directly to the buyer address by common carrier 760, or by a MPS server 762. Third party seller S8 returns 764 the products loaned to third party seller S9. Assuming the buyer wants to use a MPS service, the buyer picks up the order at MPS pickup point 774.

Of course, as long as both parties agree, third party seller S8 may pay off third party seller S9 for the products loaned by paying money rather than delivering an identical product to S9. Such a payment, however, may cause third party seller S9 to recognize a sale. Also, if third party seller S9 is a distant warehouse and owned by third party seller S8, third party seller S8 may instruct third party seller S9 to ship products the buyer ordered (either to the buyer by common carriers or by a MPS service) without an inventory loan agreement. In this case, third party seller S9 may have to recognize a sale with the buyer especially with interstate transactions.

One embodiment of a MPS server provides for a channeled route search method in which the MPS server utilizes the commuting route and channel building technique previously described to carry out searches for products buyer wants to purchase. For example, a buyer wants to buy a car battery, the buyer goes to the Internet and logs on to a MPS server in search mode. The MPS server displays a map. A buyer may click or depress and drag the buyer's mouse on the map to define a route. The buyer may further define a width of a channel to form a channeled route and search within this channel for stores that carry the products the buyer wants to purchase.

Referring again to FIG. 7, the buyer through clicks or drag of mouse define route 570. Assuming the buyer wants to search for a store with ¼-mile distance along the buyer's commuting route, the use sets a channel width size of ¼ mile. The MPS server displays a channel 572 with boundaries 578, 580. Each boundary is ¼ mile apart from the route 570. The MPS server will later search to see if there are any stores within the channel that carry the product the buyer wants. The MPS server accesses a database that contains stores with information such as: name, products carries, product price, address (with zip code) and telephone number etc.

The MPS server first determines all the Zip Codes that are covered by the channel. A zip code is covered by the channel as long as any portion of the zip code area is within the channel. For example, zip codes 92001 and 92003 are covered by channel 572. Zip code 92005 and 92009 are not. The MPS server goes to a database to search for all stores that carry car batteries and also with zip codes 92001 or 92003. All the car battery carrying stores with zip codes 92001 or 92003 are selected for the next test, and those stores with other zip codes, e.g. 92005 or 92009, are disregarded. If no stores are found in this search, the buyer may change the width of channel or change the buyer's selected route to launch another search. If there are stores that carry car batteries with channel matching zip codes (i.e.. with zip codes that match 92001 or 92003), the MPS server saves these stores in memory and goes to the next step.

The MPS server searches for all the street names covered by (or within) the channel. Any street name or avenue name is covered by (or within) the channel as long as any portion of the street or avenue is inside the channel. For example, the channel covers Texas Street 592 and also Robinson Ave 594. MPS server compares all the street names within this channel to the street name of those stores with matching zip codes selected from above step. At this stage, all car battery carrying stores, with matching zip codes and with street names matching any of the street names within the channel are selected for the next test and the others are disregarded. For example, after the zip code test, all stores with street names such as “Hawthorn Street” 582 are disregarded and all stores with street names such as “The 31st Street” 584, Texas Street 592 or Robinson Ave 594 are selected for the next test. This is because Hawthorn Street in not covered by the channel and 31st Street and Texas Street are. Again, if there is no match found, the buyer can either enlarge the width of channel or change the buyer's commute route to launch another search.

If there are stores that match the above tests, the MPS server goes to the next step. The MPS server, after the buyer defines the width of the channel, can determine the street numbers (or street addresses, as sometimes called by people) at the boundaries of the channel. That is, the MPS server can determine the street numbers of points such as M 588 and N 590. The MPS server then determines if those matching stores from the above steps have a street number that falls between the boundary points such as M and N. If the store does have a street number that falls between boundary points like M and N, the store is selected and is presented to the buyer, if not, the store is screened out and disregarded. For example, suppose the MPS server determines the address number of M 588 is 2002 31^{st} Street and the address number of N 590 is 1800 31^{st} Street, a store with street address number 1900 31^{st} Street will be selected and a store with address 2300 31^{st} Street is disregarded. If no store is selected, the buyer can modify channel width and commute route to perform another search. After the buyer finds those stores that carry products the buyer wants to but by using this search method, the buyer can go to the store's web site and place order. The buyer then decides whether the buyer wants to use a MPS service for pickup. If the buyer wants to, the MPS server goes to step 406 (FIG. 4) and continues the procedures as described previously.

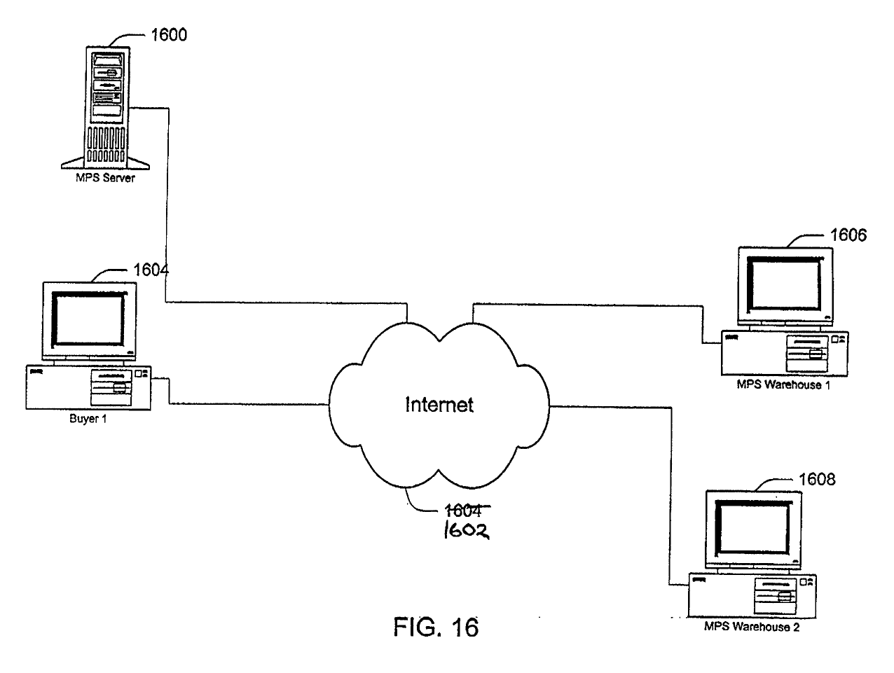

FIG. 15 is a flowchart presentation of the above search method. A buyer uses a Web browser to access a MPS server at step 800. The buyer enters a channel search mode at step 802. The buyer defines a route and a channel as previously described in step 804. The MPS server displays the channel to the buyer at step 806. The user selects a product to search for at step 808. The MPS server searches a store database for stores carrying the searched for product at step 810. The MPS server determines channel Zip codes covered by the channel as previously described at step 812. The MPS server matches the channel Zip codes found in step 812 to store Zip codes of stores found in step 810. The MPS server determines if any store Zip codes matched any channel Zip codes at step 816. If no matches were found, the buyer is invited to modify the search parameters at step 818.

If the MPS server determines that there are matches between the channel Zip codes and the store Zip codes, the MPS server determines the street names covered by the channel in step 820. The MPS server matches store street names to channel street names to determine if a store might fall within the channel at step 822. If there are no matching store street names and channel street names, the buyer is invited to redefine the search parameters at step 818.

If the MPS server determines that there are matches between the channel street names and the store street names, at step 826 the MPS server determines if a store street number is within the channel boundaries as previously described. If there is a store street number within the channel boundaries, the MPS server displays the store to the buyer at step 828. If there are no store numbers within the channel boundaries then the MPS server invites the buyer to redefine the search parameters at step 818. In one embodiment of a MPS server, the MPS server allows a third party seller to search for another third party seller within a specified territory. This method is the “Territory Search Method” referred to earlier. Referring again to FIG. 14, third party seller S8 750 uses this method to locate affiliated third party sellers S9 754 and S10 756 that are within a territory 780 of a MPS warehouse 700 that serves a buyer's 752 preferred pickup point 774. The MPS server may operate on a territorial basis, i.e. a MPS warehouse may be assigned a regional territory 780 and serve a number of pickup points 774 and 778 that are within its territory while other MPS warehouses may cover and serve other pickup points 768 within the other MPS warehouses respective territories.

When the buyer places an order with third party seller S8 and the buyer wants to use MPS services, the buyer tells third party seller S8 a pickup point ID number that is assigned and used to identify the buyer's preferred pickup point. Third party seller S8 then transmits the buyer's pickup point number along with all the addresses of its affiliates to the MPS server. The MPS server uses the transmitted buyer pickup point number to identify the MPS warehouse that serves the buyer's preferred pickup point.

In this embodiment of a MPS server, every MPS warehouse is assigned a territory. A MPS server's territory is determined by a MPS server according to criteria such as: number of buyers served, buyers' demographic distributions, distances a MPS has to travel, time a MPS spends when traveling to MPS pickup points etc. Every territory, e.g. 780, has its boundary, e.g. 782, and may be in different shapes as needed, e.g. it may be in the shape of rectangular, circle or other irregular shapes. Each point on the boundary has a known distance and relative direction to MPS warehouse; therefore the street address of each point on the boundary can be determined.

The MPS server then determines the zip codes and street names that are covered by the territory using the same method as previously described in the channeled route search method along with the affiliates' addresses provided by the third party seller S8, the MPS server may be able to identify those affiliates that are within the territory of the MPS warehouse which serves the buyer's pickup point. Using the same procedures as used in the channeled route search method, the MPS server first screens out those affiliates with zip codes not covered within the territory. The MPS server then screens out those affiliates with street names not covered by the territory. Finally, by establishing the addresses at the boundary, the MPS server may determine those affiliates with addresses that are covered by the MPS warehouse territory. The MPS server then presents these affiliates to the third party seller S8 for selection.

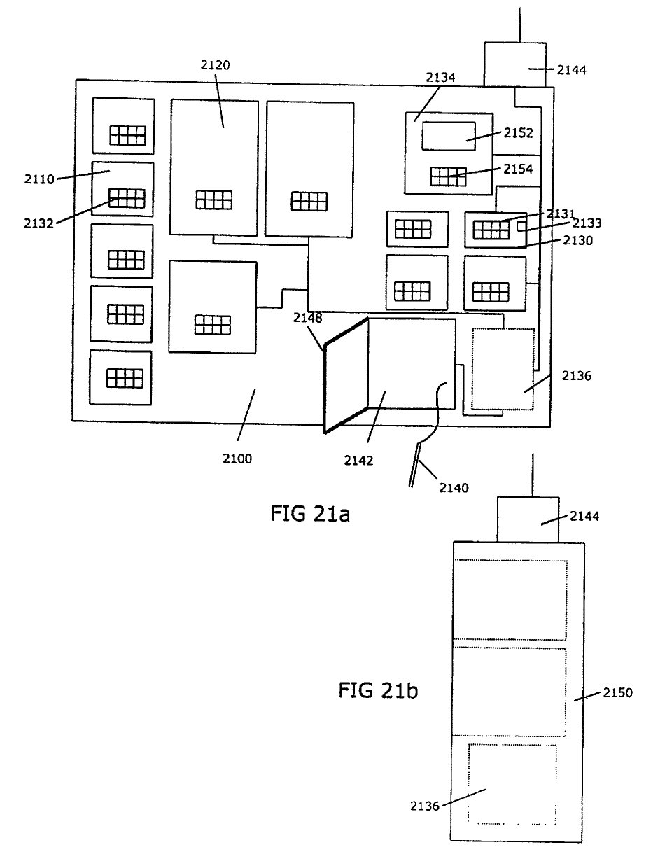

Referring now to FIG. 23, In an MPS server in accordance with an embodiment of the present invention, the MPS server is operated with multiple MPS warehouses. In this embodiment, each warehouse covers its own territory. The buyer/user goes to a MPS web site, inputs the beginning and end address to define his route. The user may use other information such as zip codes, telephone numbers or landmarks to define his route as described before. The MPS server, according to these user route information, determines the territory that serves the user. For example, route 2302 is covered by territory 2304 that is assigned to warehouse 2310. A user route my be covered by more than one territory, for example, route 2320 is covered by territory 2322 and territory 2324.

In one embodiment of a MPS server, a buyer specifies another party to pickup the buyer's products. The buyer uses a MPS server to modify the pickup point to be a place where a picking up person prefers. The buyer can also specify the name of the picking up person and request that a MPS operator check the ID of the person who picks up the product to ensure proper pickup. In the case where the MPS is a locker kiosk including a plurality of lockers, the buyer can pass the code that is used to open the locker to the receiver so that the receiver can open the locker to take the product out of the locker. In the case where the MPS server is operated by an entity that engages in the business of delivery or transportation, the service that MPS server provides is the transport of the buyer's product or packages to a pickup point the picking up person desires and waits for the picking up person to pickup.

In one embodiment of a MPS server, Fixed Pickup Stations (FPSs) are established within a territory established by a MPS server. For example, there may be stores, e.g. gasoline stations, convenience stores or super markets etc, that are located within the previously described available pickup points selection area. The MPS server may wish to contract with these stores to be pickup stations for MPS buyers. If a store agrees and an agreement is reached by the entity operating a MPS server and the store operators, the store becomes a FPS and will be one of the pickup points that are available for MPS buyers to select as pickup points. The MPS server then arranges for products ordered by buyers to be shipped to the FPS. Each FPS station may be used as a pickup point as well as a drop off point, the same way as a regular MPS.

A MPS can be a receiving station as well as a drop off station. A drop off station is a station where a user submits to MPS personnel packages the user wants the MPS service to ship to a receiver. The MPS server, after receiving packages dropped off from the user ships the packages back to a MPS warehouse for distribution. After distribution, the packages may be shipped to a MPS pickup point that is convenient to the receiver's commuting route, or shipped by other means, such as shipped by a common carrier, e.g. UPS, for delivery to a receiver. In the case where a MPS server is a delivery or transportation business entity, such as FedEx, a MPS can be used as a pickup station for those designated receivers to pickup their packages. A MPS can also be used as a drop off station for those users to drop the packages they want the MPS server to ship to the packages receivers. Again, after a MPS receives such packages from the user, the MPS will ship the packages back to a MPS warehouse for distribution.

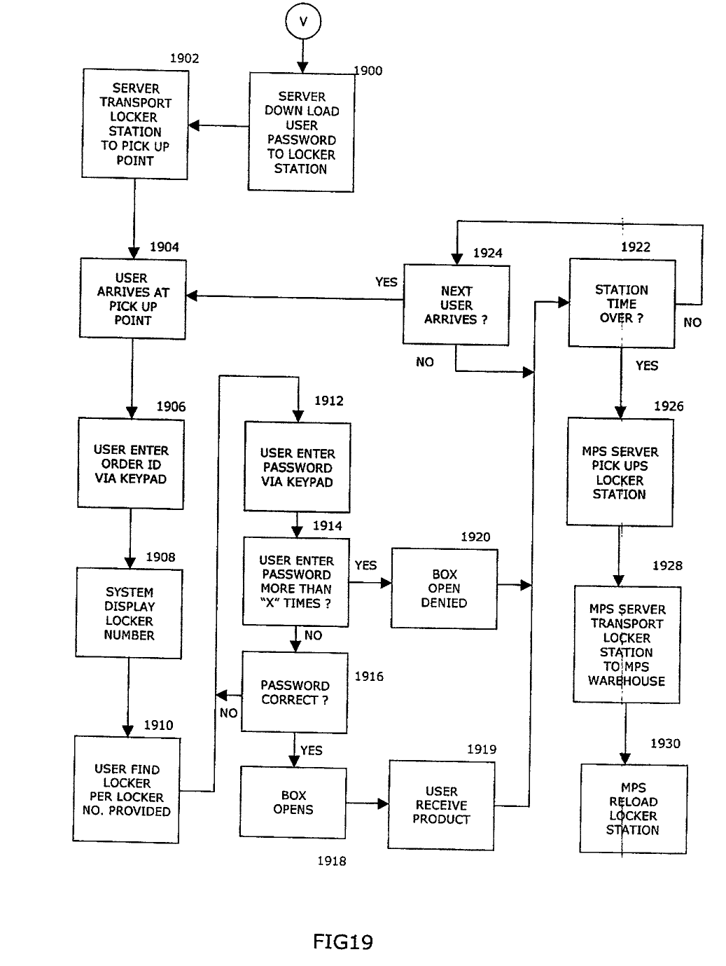

Referring now to FIG. 21a and FIG. 21b, in a MPS locker station in accordance with an embodiment of the present invention, the MPS locker station 2100 side view 2150 includes a plurality of lockers such as lockers 2110, 2120 and 2130, which enclose products ordered by the buyers. Each locker is electrically coupled to a microprocessor or controller 2136 for operation of the locker kiosk. The controller is electrically coupled to the lockers by a keypad as exemplified by keypad 2131 and an electrically actuated lock or bolt as exemplified by electrically actuated lock 2133 of locker 2130. This locker kiosk, herein referred to as “locker station”, is portable and is transported to the assigned pick up point after the locker station is loaded with products the buyer ordered and will be stationed at the pick up point during the station time. The locker station, like other kinds of pick up stations, has the capacity to carry all kinds of products. For instance, in one embodiment of a MPS kiosk, in addition to the ability to carry general non-perishable products, the MPS kiosk is equipped with a cooling device to carry food or floral products. The cooling system, just like those installed on other pick up stations, may be a refrigerator powered by electricity or solar power. The cooling system may also be an insulating system that is cooled by ice, dry ice or other means. Those lockers 2110, 2120, 2130 installed on the locker station 2100 can be opened by using an entry code (i.e. a password) assigned temporarily to the locker and given to a buyer. Lockers may vary in size. A buyer, after completing his order, receives a locker identifier (e.g. a product ID) and an access code (e.g. a password) to open the locker. The buyer goes to the pick up point where the MPS locker station is positioned, and uses the identifier and access code to identify and open the locker to receive the product ordered. In one embodiment in accordance with the present invention, the locker station is secured to the ground or a wall by a lock so that it cannot be moved easily. In this way, it may not be necessary for an operator to attend to the kiosk during operation.

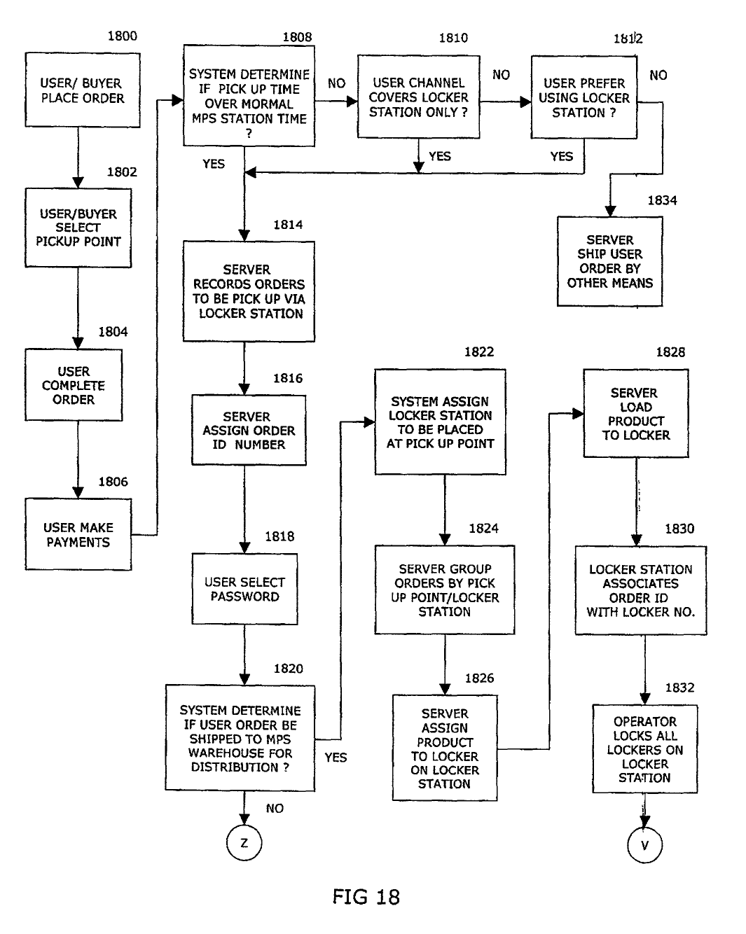

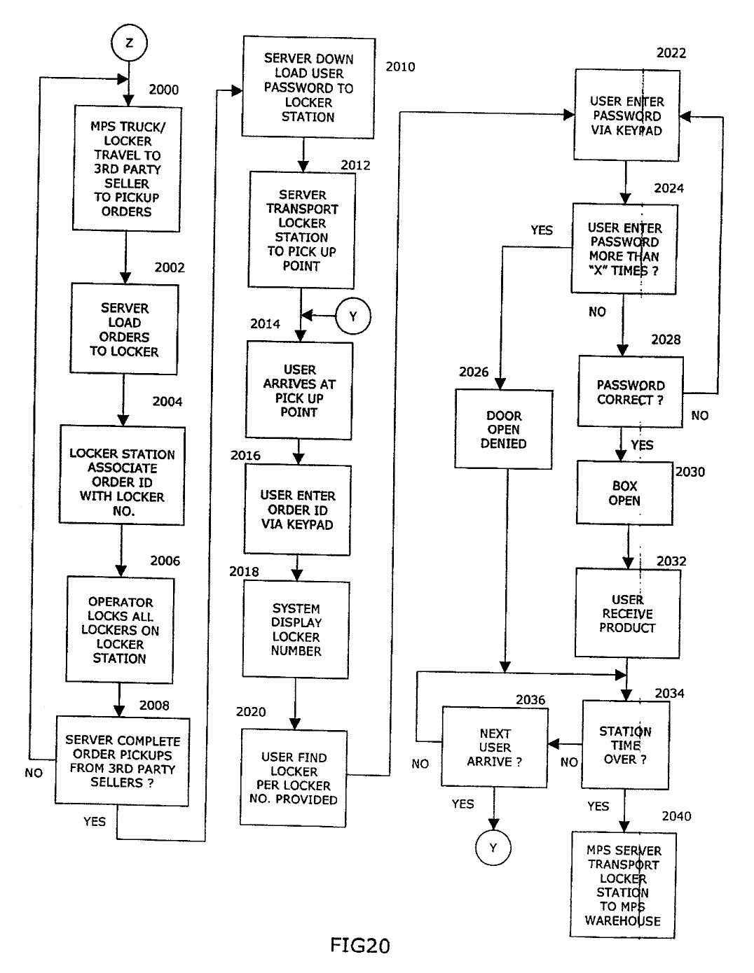

Referring now to FIG. 18, FIG. 21, and FIG. 22, a user/buyer places an order 1800 and selects his preferred pick up point 1802. When the user completes his order 1804, he makes payments. The payments may be made by using credit card, by using checks or by other means 1806. Steps 1800 to 1806 are similar to steps 100 to 174 of FIG. 1 as described before. The system reviews the user's entry for pick up time and determines if the user's preferred pick up time passes normal MPS station time. A locker station, because it can be operated without operator, can be assigned a station time much longer than that of a normal station that is attended by an operator. A user's order may be assigned to a locker station if the user wants to pick up order at a time that passes normal station time 1808. Also, the user may be assigned to a locker station to pick up his order, if his preferred channel covers locker station only 1810, or the user prefers to pick up at a locker station 1812. The user's order will be shipped by other means, e.g. normal MPS station . . . etc, if it is not transported by locker station 1834.

The server records those orders that will be handled by locker station 1814. The server then assigns an order identifier (an ID number) to the user for his order 1816. The order ID may be the seller's sales order number or other numbers defined by seller. In one embodiment, the seller may use MPS server's shipping sticker number 2202 (FIG. 22) as the order ID. MPS server uses, and sends to third party sellers for their uses, shipping stickers 2200 with bar codes 2204 that represents shipping sticker number 2202. The seller fills out necessary information on the sticker and sticks the sticker at the out side the order package. The uses of sticker will be disclosed later. The user make a record about this order ID number as he will use this number later to find the locker that contains his order. The user selects a password at step 1818.

In another embodiment in accordance with the present invention, the MPS server arranges to have user orders placed by a third party seller to be transported to MPS warehouse and then the server loads those orders to a locker station 1820. In this embodiment, the MPS server either has the third party seller ship orders to a MPS warehouse or the operator of the MPS server picks up these orders from third party sellers then ships them back to a MPS warehouse where locker stations are waiting to be loaded. The MPS server assigns each locker station a pick up point to where the locker is to be placed at 1822. The MPS server groups orders by pick up points. The operator of the MPS server then transports those orders to the locker station that will be placed at the pick up point 1824. The MPS Server then assigns each order with a locker (e.g. locker 2120 FIG. 21) to be stored in 1826. The MPS server assigns orders to lockers based upon order sizes, product character (e.g. a perishable product like food or floral product may be assigned to a locker with cooling capacity) or other criteria such as: the MPS server may place the order of a handicapped or short user at a lower locker for his convenience . . . etc. The operator of the MPS server then loads product into the assigned locker 1828. The MPS server then registers the product order ID with the locker so that the system may relate product order ID to its storing locker 1830. In a registration process in accordance with an embodiment of the present invention, the operator deposits user orders into a locker 2110, then the operator uses keypad 2132 (FIG. 21) on the locker to enter the product ID displayed on the product package into the locker's system. Because each locker has a keypad installed on its door and each keypad is separately wired to the microprocessor or controller 2136 of the main keypad 2134, the microprocessor can relate the product order ID to its storing locker. The microprocessor contains memory means to record the product ID entered through each keypad. In another embodiment of the registration process in accordance with the present invention, the operator can use an optical scanner pen 2140 to scan the bar code 2204 on the MPS shipping sticker 2200 (FIG. 22). The sticker is placed to the outside of the order package by the seller. Each locker has an optical scanner pen wired to its inside. FIG. 22 shows a locker 2142 with a door 2148 opened and a scanner pen 2140 wired to the inside of the locker. Each scanner pen is separately wired to the microprocessor of the main keypad. The shipping sticker contains a bar code 2204 that represents the product ID 2202. By scanning the bar code with the scanner pen, the microprocessor relates each locker with the product order ID of the product it stores. After the operator loads all the orders into lockers, the operator locks all the lockers on the locker station 1832. The operator then down loads, from the MPS server, user passwords to the locker microprocessor 1900 (FIG. 19). The locker station then registers these passwords. In one embodiment in accordance with the present invention, the down load is performed through a wiring connection from a MPS server to a locker station's microprocessor. In another embodiment, the down load is performed through a wireless radio transmission between the MPS server and the radio transmission device 2144 (FIG. 21) connected to the locker microprocessor. The operator of the MPS server then transports the locker station to its assigned pick up point 1902. The locker station stays at the pick up point. A locking device may lock and fix the station to the ground or to a wall so that it cannot be removed easily. When the user arrives at the locker station 1904, he keys in the order ID through the main keypad 1906 (also 2134 FIG. 21) by using keypad 2154 (FIG. 21). The microprocessor finds the locker that related to the order ID. The display device 2152 (FIG. 21) on the main keypad 2134 (FIG. 21) displays the locker number of the locker that stores user orders 1908. The user then finds the locker storing his order by locker number provided 1910. At step 1912, the user keys in the password by using the keypad 2132 (FIG. 21) on the locker 2110 (FIG. 21). If the password is entered correctly, the locker will open 1918, and the user receives the product in the locker 1919. If the user enters a wrong password, the system asks the user to enter it again 1912. If the user fails a certain time of password entries, the user is denied to open the locker 1920.

The station stays at the pick up point for a determined station time, within this station time the station serves other users that arrive 1924. When station time is up, the operator of the MPS server recovers the locker stations 1926 and transports the locker stations back to a MPS warehouse 1928 for reloading 1930.

Referring again to step 1820 of FIG. 18. In another embodiment of a MPS system in accordance with the present invention, the MPS truck may carry locker stations and travel to third party sellers to collect user orders then goes directly to the assigned pick up point without going back to a MPS warehouse.

Referring now to FIG. 20, the MPS truck travels 2000 with lockers to third party seller to pick up user order. The MPS operator then selects a locker to store the order he just picked up 2002. The operator then registers order ID with locker 2004 and locks all the lockers 2006. Steps 2002 to 2006 is similar to steps 1828 to 1832 of FIG. 18 and can be understood by referring to these steps. The MPS truck/locker travels to other third party sellers to collect orders until all orders are collected 2008. The operator of the MPS sever down loads user password through wireless radio transmission between the MPS server and the radio transmission device connected to the locker microprocessor 2010. Steps 2012 to 2036 describe the steps from locker station's arrival at pick up point to the over of station time, which are similar to steps 1904 to 1922 of FIG. 19 and previously described before and are not repeated here. At step 2040, the MPS locker station is transported back to a MPS warehouse when station time is over.

In another embodiment of locker station in accordance with the present invention, a locker station may be fixed at a pick up point as a FPS (Fixed Pickup Station) described before and cannot be moved. In this embodiment, the operator of the MPS server ships user orders to the locker station and loads the lockers with orders. The MPS server may receive user pickup information transmitted from the locker station on a regular basis so that the MPS server may monitor the activities of the locker station.

In another embodiment in accordance the present invention, the operator of a MPS server may decide not to install all lockers with keypads but instead use a main keypad to receive user key-ins and to control lockers activities. In this embodiment, the user enters order IDs into the main keypad. The main keypad then displays the locker number of the locker that stores the user order. The user then enters password into main keypad. If the password is entered correctly, the locker door will open for the user to receive his order. In this embodiment, the main keypad will be the only keypad installed and the operator keys in product ID together with the locker number that stores the order (unless the optical scanner pen is used). The purpose of entering product ID with locker number is to allow the locker to relate those information together.

If the user fails to pick up his order timely, operator of the MPS server may decide that it will ship those products back to the same pick up point for the user to pick up again. The user may not want to change password and the locker that stores the order. The operator of the MPS server may establish a policy that allows users to pick up products within a determined number of days. Beyond this predetermined period, the product may be returned to the sender or handled in a way according to the operator of the MPS server's policy.

In one embodiment in accordance with the present invention, it should be noted that a locker station can be a drop off point also. In this embodiment, the user goes to a MPS system and tells the system the size of the drop off load. If the MPS server determines that a locker will be available for receiving drop off, the system gives the user an order ID and allows the user to set up a password. The user goes to the pick up station then keys in the order ID and password into the main keypad. If the order ID and password are entered correctly, the microprocessor opens the locker and the locker is available for the user to deposit the package he wants to drop off. The user may post instructions on the package as how he wants the package to be handled. The user may give the order ID and the password to a third party receiver. The third party receiver can use the order ID and password to find and open the locker and receive the product.

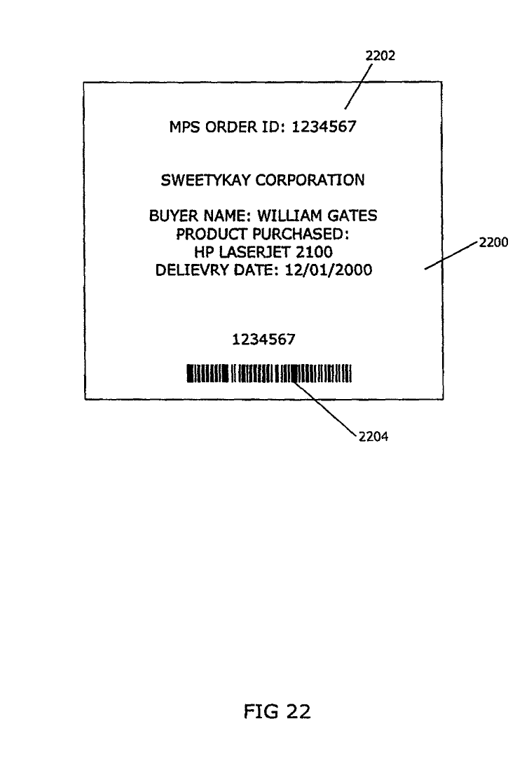

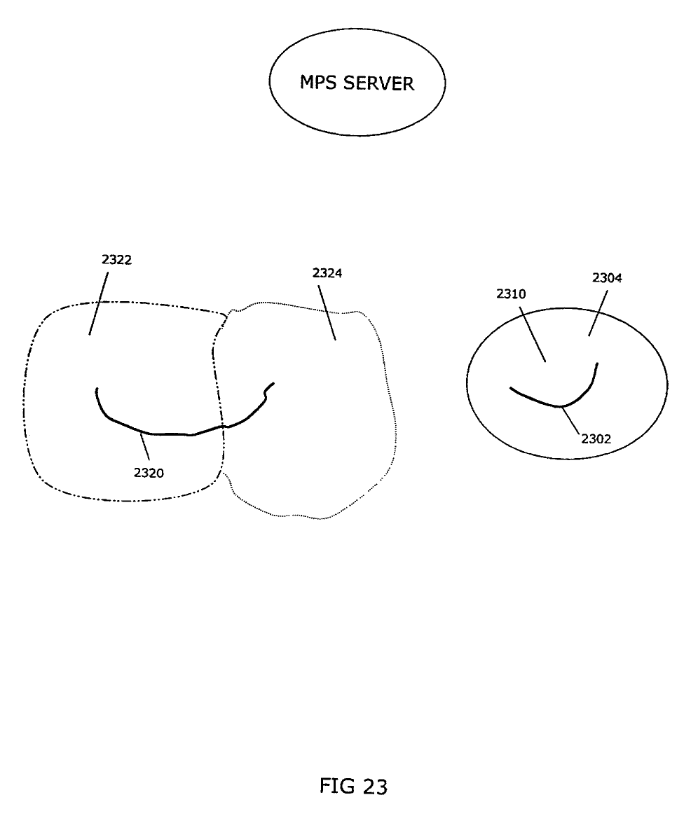

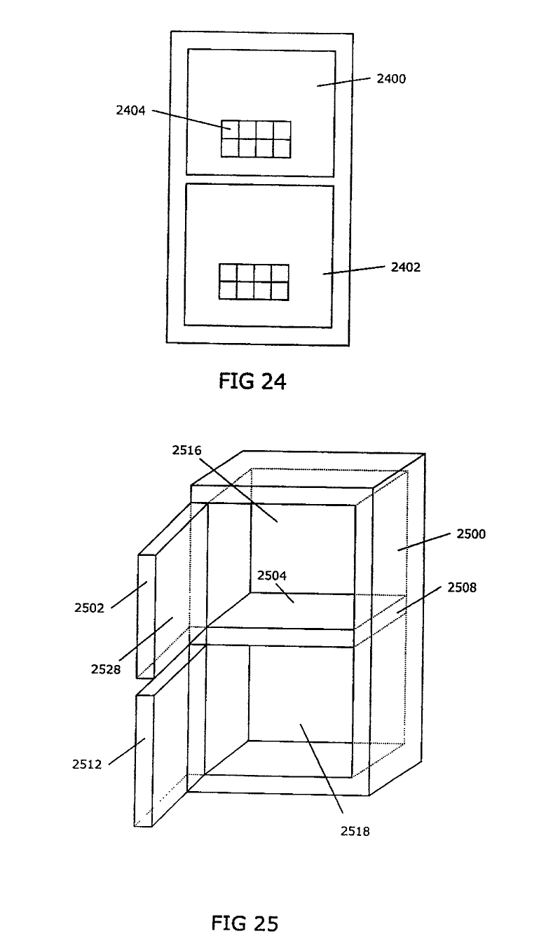

In another embodiment in accordance with the present invention, two lockers in the locker station can be adjusted to become one larger size locker. FIG. 24 shows two lockers 2400 and 2402 with keypad 2404. FIG. 25 shows the same lockers with doors 2502, 2512 opened. Divider 2504 is at its down position. When the divider 2504 is secured at this down position, the whole locker construction 2500 includes two separate lockers 2516 and 2518. A unit 2528 is shown in its up position and is hidden in door 2502. FIG. 26 shows the same locker as in FIG. 25 with divider 2604 in its up position. Unit 2610 is a bolt unit, now in its “in” position. This bolt unit is installed to secure divider 2604 to the wall when it is at its down position. Bolt unit 2608, constructed within door 2602, is shown in its down position. When doors 2602 and 2612 are lined up and bolt unit 2608 is in its down position, the bolt unit goes into a slot in the door 2612 and thereby connects door 2602 and door 2612 into one piece. Now, if the divider 2604 is at its up position, the whole construction 2600 is now one locker with lager size then before.

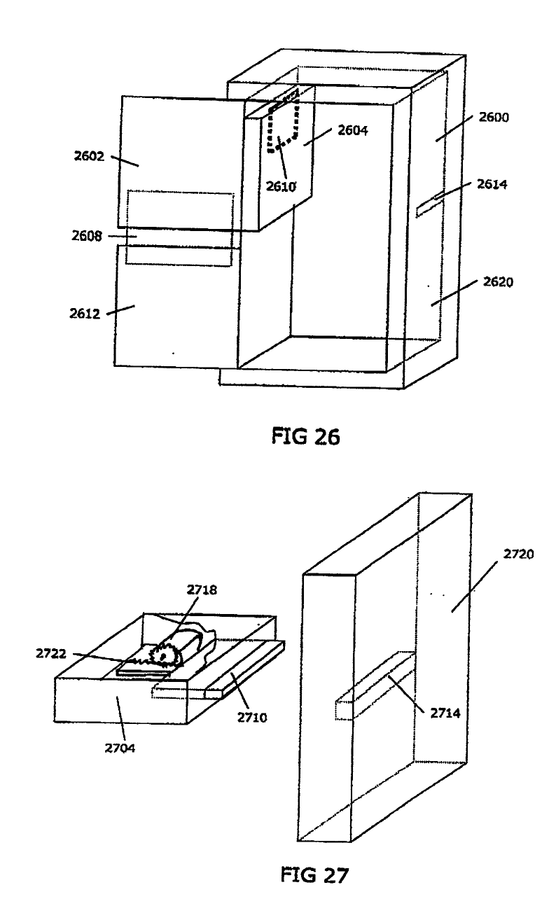

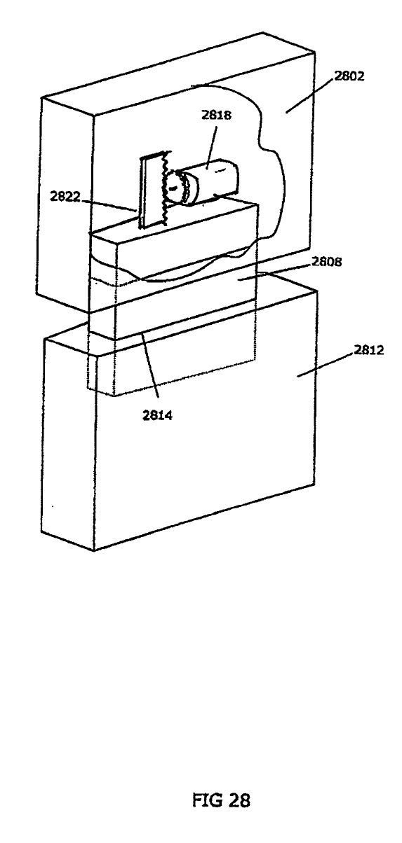

Referring now to FIG. 27, 2720 is one of the walls of locker station, and is the same as unit 2620 as shown in FIG. 26. 2714 is a slot built into wall 2720. Divider 2704, the same unit 2604 in FIG. 26, is now in its down position. Divider 2704 contains a bolt unit 2710 that can move in and out. When a MPS operator positions the divider at its down position and makes the bolt unit 2710 at its out position, the bolt unit goes into slot 2714 and makes the divider “locked” to the wall and secured at this place. The movement of bolt 2710 may be accomplished by many different means. FIG. 27 illustrates one of these means where the movement is controlled by an electric motor 2718 that is connected to the bolt by a gear unit 2722. FIG. 28 shows two doors 2802, 2812 that are the same units as doors 2602, 2612 in FIG. 26. 2808 is a bolt that can move up and down is now at its down position. When bolt 2808 goes down, it goes in to slot 2814 in door 2812 and lock door 2802 and 2812 into one piece. The movement of bolt unit 2808 can be achieved by many different means. FIG. 28 illustrates one of these means where an electric motor 2818 and gear unit 2822 control the bolt movement.

Referring again to FIG. 25, when the operator prefers to use two lockers with smaller spaces, he will lower divider 2504 (or 2704 FIG. 27) to its low position and switch the motor inside the divider to make the bolt go to its out position, the whole construction become two separate lockers. If the operator prefers to use one locker with a larger space, he can switch the bolt in the divider to its in position 2610 and raise the divider to its up position 2604. The operator then lines up those two doors, switches the bolt in the upper door to its down position 2608, and connects those two doors in one piece, creating one locker 2600 with la arger space as shown in FIG. 26. The same method can be used combine three or more lockers into one big locker.

Referring again to FIG. 4, when the user/buyer goes to a third party seller's web site and purchases on line 404, he makes decision if he wants to use MPS service as a delivery method 406. If he does, he gets access to MPS system 408 to use MPS route selecting mode. In the route selecting mode, user selects routes, pick up points and selects pick up times (as covered previously from step 112 to 138, FIG. 2). There are many different ways to get access to MPS route selecting mode. In one embodiment, the user is transferred (or linked) to MPS server from the third party's web site. MPS server maintains system software that handles all the functions in the route selection mode. MPS server also maintains a data base that keeps all users' information, such as: users' preferred routes, preferred pick up points, pick up times, addresses, preferences . . . etc. The third party seller, when in need of user information or wishes to see pick up point information, route information . . . etc can log on to MPS server to get access to third party information. The MPS server collects all order information, e.g. order sizes, pick up point, pick up time, name . . . etc, from all third party sellers and arranges shipment of products to MPS warehouse and dispatches MPS stations to pick up points. Shipment information is then transmitted to the third party seller for its record. In another embodiment in accordance with the invention, the MPS server, under arrangements with the third party seller, down loads route selecting system software with/without user information to the third party's system. In this way, a user uses route selecting mode within third party's web site (system) to select route, pick up point and pick up time . . . etc. Order information and pick up information is then transmitted to the MPS server for the MPS server's use to arrange shipment when the order is completed. The MPS server constantly updates third party seller for pick up point changes, route changes, map changes . . . or other necessary changes.

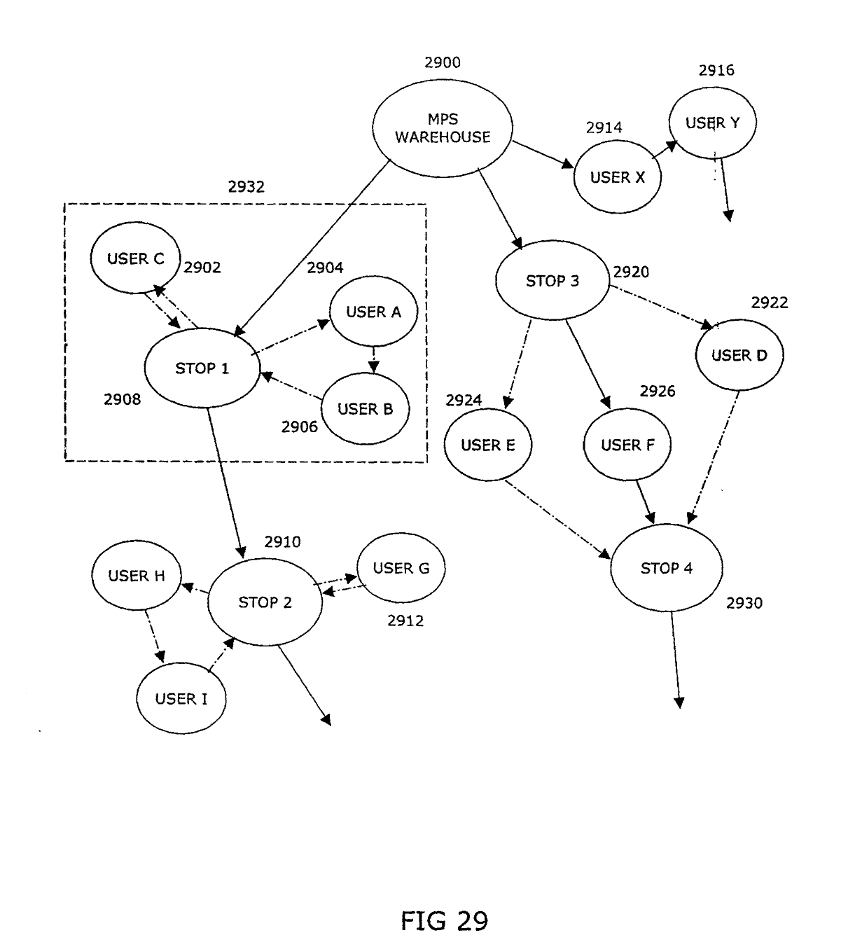

In another embodiment of the present invention, one or more subsidiary delivery personnel (SDP) are involved in the delivery process to more efficiently perform delivery functions as shown in FIG. 29. In the traditional delivery model, a carrier (e.g. a delivery truck) loaded with goods leaves warehouse 2900 and travels to customer X 2914 and drops off the goods the customer ordered and moves to the next customer Y 2916 and the next customer . . . In this traditional model, the carrier operator acts alone and covers the whole delivery route by himself. In an exemplary embodiment of a MPS system, a carrier is accompanied by (or carries) at least one subsidiary delivery personnel (SDP) with it. A subsidiary delivery personnel (SDP) is a person that stays with a carrier and delivers goods assigned to him to his customer after the carrier stops at a stop point. After the carrier (e.g. a truck or a MPS truck) leaves warehouse 2900, it stops at predetermined stop points and dispatches its SDP(s). The SDP(s) who carries the assigned delivering goods with him, delivers the goods to its customers. See FIG. 29. As an example, when the currier stops at Stop 1 2908, the carrier dispatches a SDP to deliver goods to user/customer A 2904 and to user/customer B 2906. Also the carrier dispatches another SDP to deliver goods to user/customer C 2902. The system predetermines stop points. An ideal stop point is a place where the carrier stops and can most efficiently utilize SDPs to cover a determined delivery area, such as area 2932. All SDPs return to the stop point after they deliver the goods that are assigned to them. SDPs then get on to the carrier, the carrier then travels to the next stop point (Stop 2) 2910 and repeats the cycle to complete the next delivery.

A secondary transportation means (STM) may be used by a SDP to aid his delivery duty. A STM is a transportation equipment which may be a bicycle, a motorcycle or a vehicle. The carrier is equipped with means to carry these STMs. For example, the carrier may equip racks or is hooked with a trailer to carry STMs such as bicycles. When a carrier stops at a stop point, it dispatches its SDPs. The SDP may walk to deliver his assigned goods or get a STM to aid him with his delivery. For example, a SDP may get a bicycle (a STM) to help him with a speedier delivery. The carrier itself, after dispatches its SDPs, may travel to a user/customer to deliver goods to the user. For example, the carrier may stop at Stop 3 2920, dispatches its SDPs and it itself may travel to user F 2926 to deliver goods to user F. The carrier then travels to the next stop point Stop 4 2930, and waits for its SDPs to return after they deliver their assigned goods. The SDPs are instructed previously to go to a predetermined stop point (Stop 4 2930) to meet the carrier after they complete their delivery. The carrier receives its SDPs and moves to the next stop point. The solid lines in FIG. 29 represent the movements of the carrier and the dot lines represent the movements of SDPs. The dotted line 2932 however, represents the area SDPs cover when the carrier stops at stop point 1 2908.

Having thus described several exemplary implementations of the invention, it will be apparent that various alterations and modifications can be made without departing from the inventions or the concepts discussed the herein. Such operations and modifications, though not expressly described above, are nonetheless intended and implied to be within the spirit and the scope of the inventions. Accordingly, the foregoing description is intended to be illustrative only.

What is claimed is:

1. A method for scheduling and delivery of an ordered product to a buyer along the buyer's commuting route, comprising:
receiving route information from a buyer;
generating a route from the route information;
selecting from a plurality of pickup points a pickup point based on the route; and
dispatching a portable locker station to the pickup point, the portable locker station enclosing the ordered product.

2. The method of claim 1, wherein the route information includes at least two landmarks and generating a route further includes finding a route of shortest distance between the two landmarks.

3. The method of claim 1, wherein the route information includes at least two sub-routes and generating a route further includes finding a route of shortest distance between the two sub-routes.

4. The method of claim 1, wherein the portable locker station includes a plurality of lockers for enclosing products, each of the plurality of lockers having a unique access code, the method further comprising transmitting to the buyer an access code for a locker enclosing the buyer's product, the locker selected from the plurality of lockers.

5. A data processing system adapted to schedule and deliver an ordered product to a buyer along the buyer's commuting route, comprising:
a processor; and
a memory operably coupled to the processor and having program instructions stored therein, the processor being operable to execute the program instructions, the program instructions including:
receiving route information from a buyer;
generating a route from the route information;
selecting from a plurality of pickup points a pickup point based on the route; and
dispatching a portable locker station to the pickup point, the portable locker station enclosing the ordered product.

6. The data processing apparatus of claim 5, wherein the route information includes at least two landmarks, the program instructions for generating a route further including finding a route of shortest distance between the two landmarks.

7. The data processing apparatus of claim 5, wherein the route information includes at least two sub-routes, the program instructions for generating a route further including finding a route of shortest distance between the two sub-routes.

8. The data processing apparatus of claim 5, wherein the portable locker station includes a plurality of lockers for enclosing products, each of the plurality of lockers having a unique access code, the program instructions further including transmitting to the buyer an access code for a locker enclosing the buyer's product, the locker selected from the plurality of lockers.

9. A portable locker station, comprising:
a plurality of lockers, each of the plurality of lockers having an electronically actuated lock;
a controller electrically coupled to each of the electronically actuated locks, the controller having means for storing a plurality of access codes associated with the lockers; and
a keypad electrically coupled to the controller whereby a buyer enters an access code to unlock an associated locker.

10. The portable locker station of claim 9, further comprising a removable divider between adjoining lockers whereby a single locker is created from two or more lockers by removing the divider.

11. The portable locker station of claim 9 further comprising a plurality of keypads, each keypad corresponding to a single locker from the plurality of lockers.
